(19) United States
(12) Patent Application Publication
(10) Pub. No.: US 2026/0189916 A1
(43) Pub. Date: Jul. 2, 2026

(54) SYSTEM, METHOD, APPARATUS, AND COMPUTER PROGRAM PRODUCT FOR UTILIZING DIGITAL CODES TO CAPTURE AND/OR ANALYZE AN IMAGE OF A MOBILE DEVICE TO DETERMINE A MOBILE DEVICE CONDITION STATUS

(71) Applicant: Assurant, Inc., New York, NY (US)

(72) Inventors: Karl Medina, Oceanside, CA (US); Wiliam Liebenrood, Ft. Worth, TX (US); Rajiv Dwivedi, Barlett, IL (US); Ram Reddy, Irving, TX (US); Claudio Miraka, Chicago, IL (US); Sahar Ghanavati, New York, NY (US)

(21) Appl. No.: 19/436,857

(22) Filed: Dec. 30, 2025

Related U.S. Application Data
(60) Provisional application No. 63/740,447, filed on Dec. 31, 2024.

(51) Int. Cl. H04W 12/50; G06F 16/955; H04L 67/02; H04L 67/06; H04W 12/77

(52) U.S. Cl. CPC H04W 12/50; G06F 16/9554; H04L 67/02; H04L 67/06; H04W 12/77

(57) ABSTRACT

Embodiments of the present disclosure provide for utilizing digital codes to capture and/or analyze an image of a mobile device to determine a mobile device condition status of the mobile device. Such embodiments may include detecting, via an image capture device of a second mobile device, one or more digital codes displayed via a screen of a first mobile device. Such embodiments may additionally or alternatively include processing the one or more digital codes to initiate an electronic connection between the first mobile device and the second mobile device. Such embodiments may additionally or alternatively include causing the second mobile device to capture at least one image of the first mobile device via the image capture device of the second mobile device. Such embodiments may additionally or alternatively include analyzing the at least one image of the first mobile device to determine a condition associated with the first mobile device.

### CROSS-REFERENCE TO RELATED APPLICATIONS

This application claims the benefit of and priority to U.S. Provisional Application No. 63/740,447, titled “SYSTEM, METHOD, APPARATUS, AND COMPUTER PROGRAM PRODUCT FOR UTILIZING DIGITAL CODES TO CAPTURE AND/OR ANALYZE AN IMAGE OF A MOBILE DEVICE TO DETERMINE A MOBILE DEVICE CONDITION STATUS,” and filed on Dec. 31, 2024, the entirety of which is hereby incorporated by reference herein.

### TECHNOLOGICAL FIELD

Embodiments of the present disclosure generally relate to computer technology, and more particularly to capture and/or analysis of an image of a mobile device to determine a mobile device condition status of the mobile device.

### BACKGROUND

Computer vision enables computers to see and understand an image. In some instances, computer vision may be used to detect and analyze the content of an image, such as recognizing an object within an image. However, existing technology is inadequate to meet the speed and precision requirements of many industries, and existing technology is unable to effectively operate in distributed device environments. There is a need for improvement in computer vision techniques and technology to enable sophisticated image processing. Moreover, human analysis is incapable of the speed and precision required for computer vision tasks. Through applied effort, ingenuity, and innovation, Applicant has solved many of these identified problems by developing embodied in the present disclosure, which are described in detail below.

### BRIEF SUMMARY

In an embodiment, a system comprises a second mobile device comprising one or more second processors and one or more second storage devices storing second instructions. In one or more embodiments, the second instructions are operable, when executed by the one or more second processors, to cause the one or more second processors to detect, via an image capture device of the second mobile device, at least one digital code of one or more digital codes displayed via a screen of a first mobile device. In one or more embodiments, the second instructions are additionally or alternatively operable, when executed by the one or more second processors, to cause the one or more second processors to capture at least one image of the first mobile device via the image capture device based at least in part on the at least one digital code. In one or more embodiments, the second instructions are additionally or alternatively operable, when executed by the one or more second processors, to cause the one or more second processors to cause analysis of the at least one image of the first mobile device to determine a condition associated with the first mobile device.

In another embodiment, a computer-implemented method is provided. In one or more embodiments, the computer-implemented method comprises detecting, via an image capture device of a second mobile device, one or more digital codes displayed via a screen of a first mobile device. In one or more embodiments, the computer-implemented method additionally or alternatively comprises processing the one or more digital codes to initiate an electronic connection between the first mobile device and the second mobile device. In one or more embodiments, the computer-implemented method additionally or alternatively comprises causing the second mobile device to capture at least one image of the first mobile device via the image capture device of the second mobile device. In one or more embodiments, the computer-implemented method additionally or alternatively comprises analyzing the at least one image of the first mobile device to determine a condition associated with the first mobile device.

In yet another embodiment, a computer program product, stored on at least one computer readable medium, is provided. In one or more embodiments, the computer program product comprises instructions that when executed by one or more computers cause the one or more computers to detect, via an image capture device of a second mobile device, one or more digital codes displayed via a screen of a first mobile device. In one or more embodiments, the instructions, when executed by one or more computers, additionally or alternatively cause the one or more computers to process the one or more digital codes to initiate an electronic connection between the first mobile device and the second mobile device. In one or more embodiments, the instructions, when executed by one or more computers, additionally or alternatively cause the one or more computers to cause the second mobile device to capture at least one image of the first mobile device via the image capture device of the second mobile device. In one or more embodiments, the instructions, when executed by one or more computers, additionally or alternatively cause the one or more computers to analyze the at least one image of the first mobile device to determine a condition associated with the first mobile device.

Various other embodiments are also described in the following detailed description and in the attached claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. Having thus described the embodiments of the disclosure in general terms, reference now will be made to the accompanying drawings, which are not necessarily drawn to scale, and wherein:

FIG. 1 illustrates a block diagram of a system that may be specially configured within which at least one example embodiment of the present disclosure may operate;

FIG. 2 illustrates a block diagram of an example apparatus that may be specially configured in accordance with at least one example embodiment of the present disclosure;

FIG. 3 illustrates a block diagram of another example apparatus that may be specially configured in accordance with at least one example embodiment of the present disclosure;

FIG. 4A illustrates an example system in accordance with at least one example embodiment of the present disclosure;

FIG. 4B illustrates another example system in accordance with at least one example embodiment of the present disclosure;

FIG. 5 illustrates an example process depicting example operations for utilizing digital codes to capture and/or analyze an image of a mobile device to determine a mobile device condition status in accordance with at least one embodiment of the present disclosure;

FIG. 6 illustrates another example process depicting example operations for utilizing digital codes to capture and/or analyze an image of a mobile device to determine a mobile device condition status in accordance with at least one embodiment of the present disclosure;

FIG. 7 illustrates another example process depicting example operations for utilizing digital codes to capture and/or analyze an image of a mobile device to determine a mobile device condition status in accordance with at least one embodiment of the present disclosure;

FIG. 8 illustrates another example process depicting example operations for utilizing digital codes to capture and/or analyze an image of a mobile device to determine a mobile device condition status in accordance with at least one embodiment of the present disclosure;

FIG. 9A illustrates an example user interface in accordance with at least one embodiment of the present disclosure;

FIG. 9B illustrates another example user interface in accordance with at least one embodiment of the present disclosure;

FIG. 9C illustrates another example user interface in accordance with at least one embodiment of the present disclosure;

FIG. 10A illustrates an example user interface in accordance with at least one embodiment of the present disclosure;

FIG. 10B illustrates another example user interface in accordance with at least one embodiment of the present disclosure;

FIG. 10C illustrates another example user interface in accordance with at least one embodiment of the present disclosure;

FIG. 10D illustrates another example user interface in accordance with at least one embodiment of the present disclosure; and

FIG. 10E illustrates another example user interface in accordance with at least one embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

In some circumstances, an image processing system is utilized to review images of an object to verify the integrity of the object (e.g., to determine information about the object, to verify the operability or functionality of the object, to verify the identity of the object, or the like). However, with a typical image processing system, it is often difficult for computer vision and/or image processing to occur within a desirable interval of time and/or within a certain degree of precision. Additionally, typical image processing systems cannot select an imaging device that captures the image and/or cannot directly control an image capture process. Thus, typical image processing systems inadequately account for and/or detect issues with an image capture process. Moreover, cumbersome software platforms may require pre-installation of image processing software (e.g., dedicated applications) which hinder execution time, security, and device and/or operating system selection for the image processing system, particularly for one-time-execution or other infrequent use environments, such as a trade-in process or device onboarding process. In an example scenario, a system may seek to verify the identity and integrity of an object using only an image of the object (e.g., a mobile device) or using an image in combination with one or more data objects transmitted from the object or from another device.

An example of a contextual environment for various embodiments of the present disclosure may be when a user triggers a remote system to verify the object (e.g., a mobile device) without having the device physically present at a particular device inspection location or a dedicated device inspection apparatus. According to some processes, a user must visit a retailer, mobile device service provider, or other device inspection location to have the device inspected and/or to verify the integrity of the device before the insurer will issue the policy and enroll the device for coverage. In another example, a user may be experiencing a fault with an object (e.g., mobile device) and may trigger an external visual triage of the object in any location. Some embodiments may utilize a self-service web application or mobile application to take photographs of their mobile device and may utilize one or more models for rapid device assessment without submitting the images for manual review. The capturing device may transmit the images to a cloud server to enable evaluation of a condition (e.g., device integrity) of the mobile device via the cloud server. Alternatively, evaluation of a condition of the mobile device may be realized without transmitting the images off the capturing device. Such processes may reduce assessment time to real time or near real time and may not delay the confirmation of coverage to the user. Various embodiments of the present disclosure further execute such processes without exposing the user or provider to fraud, such as when the user submits a photo of a different, undamaged mobile device as an attempt to obtain coverage for a previously damaged device and other fraud related problems with remote device inspection and verification.

An example system provides a time-sensitive bar code, quick response (QR) code, or other computer-generated code to be displayed by the device, and captured in a photo via the device using a mirror (e.g., a physical mirror on a wall), thereby linking the photo submission to the device that displayed the code. However, such examples may be susceptible to fraud, such as by enabling a user to recreate the code on another undamaged device and to capture a photo of the undamaged device, which risk is resolved by embodiments of the present disclosure. Still further, the code implementation may only provide for validation of the front (e.g., display side) of the device without reliably verifying the condition or status of the rear of the device and/or bezel of the device, which also may be resolved by embodiments of the present disclosure. Another risk of such implementations is that when a code is displayed on a device display, it may obscure cracks or other damages present on the screen.

To account for such technical problems, embodiments of the present disclosure provide for a device-to-device imaging process and/or a device-to-device imaging system (also referred to as an “object-to-object” process and/or system) to improve upon typical image processing system utilized to review images of an object. Various downstream functions may be facilitated via the device-to-device imaging process and/or a device-to-device imaging system. The device-to-device imaging process and/or device-to-device imaging system may utilize digital codes to capture an image of a mobile device via another mobile device to analyze the image and/or determine a mobile device condition status of the mobile device. In various embodiments, a second mobile device or another computing device comprising a camera (e.g., a separately connected or integral camera) may be utilized to capture an image of a first mobile device undergoing a review for a service, protection plan, warranty, insurance, or the like. While various embodiments herein use a “mobile device” for illustrative examples of the systems and processes of the present disclosure, it should be understood that the mobile device may be interchanged with other such computing devices comprising a camera. In various embodiments, the first mobile device or other object may include a screen configured to display a digital code, and the second mobile device or other object may include (e.g., via connection or integrally) a camera configured to capture an image of the code and/or an image of the first object for inspection and/or verification.

The first mobile device and the second mobile device, or other objects, may be connected through an electronic session to enable direct or indirect communication between the first mobile device and the second mobile device. In various embodiments, a web diagnostics session may be utilized to enable the second mobile device to capture an image of the first mobile device. Additionally, a fraud detection mechanism may be utilized during the electronic session such that the second mobile device captures the image in response to a determination that the first mobile device is recognized during the electronic session. In various embodiments, real-time assessment of the first mobile device may be realized via one or more trained models (e.g., one or more trained artificial intelligence models and/or one or more trained machine learning models). In some embodiments, a trained model may be a neural network model trained for mobile device condition detection (e.g., damage detection, crack detection, occlusion detection, screen obstruction detection, full screen detection, fraud detection, etc.). In various embodiments, the electronic session provides for automatic linking between the mobile devices and/or automatic image capture of the first mobile device.

In an example, the first mobile device may scan a digital code (e.g., via capturing an image of a digital code, such as with the mobile device camera, and analyzing the image to detect and decode the digital code) to initiate the electronic session. In another example, a user may interact with an interactive interface element (e.g., a hyperlink or other clickable interface element) of a user interface of the first mobile device to initiate the electronic session. In yet another example, the electronic session may be initiated in response to a download of a software application via the first mobile device. In some embodiments, the electronic session may be initiated using a different technique. A user may also be directed via an instruction on a screen of the first mobile device to obtain the second mobile device. The second mobile device may scan another digital code to launch one or more user interfaces via the first mobile device and/or to establish an electronic connection between the mobile devices. While an image capturing process is occurring via the second mobile device to capture an image of the first mobile device, a single digital code or multiple sequential digital codes may be rendered via a screen of the mobile device to confirm authentication of the first mobile device. In response to a successful confirmation of the authentication of the first mobile device, the second mobile device may capture an image of the first mobile device. In some embodiments, the second mobile device may automatically capture the image of the first mobile device (e.g., without an interaction or pressing of a button by a user via a screen of the second mobile device). In some embodiments, this latter capturing process may be restricted until at least one of the first mobile device or the second mobile device recognizes the other (e.g., the successful verification of the digital codes discussed above) to secure the mobile device and prevent fraud and other errors in the imaging and analysis processes. For example, this latter capturing process may be restricted until the second mobile device recognizes the first mobile device. In some embodiments, one or more filters may be applied to the image of the first mobile device to provide a digitally enhanced version of the image. In response to capture of the image and/or filtering of the image, the image may be analyzed to determine a condition of the first mobile device.

In various embodiments of the present disclosure, an object (e.g., a mobile device, personal computer, television, vehicle, or the like) may be remotely inspected for at least external defects on demand and without a dedicated inspection device. Such inspection processes may be particularly useful for mobile devices that could require inspection and/or verification in any of a number of unplanned locations or for other objects (e.g., physically fixed or remote machinery, such as production line equipment) that are not easily moved to a controlled inspection location. In some example contexts, users may purchase objects and/or object-related services such as insurance plans, warranties, extended warranties and/or other device protection plans to protect their objects (e.g., mobile devices and smart phones) from damage, theft, loss and/or the like. In some instances, a user may purchase such a plan at the point of sale or other controlled location, such that the condition of the device is known to be new and qualifies the device for coverage. However, in some cases, a user may wish to purchase protection or otherwise inspect and/or verify the condition of the device after the device has been in their possession or after transfer of the device to the user from an independent third party, either directly from an insurance provider, or through their mobile device service provider, or other provider not in the same physical location as the user. The provider must be able to quickly verify the integrity of the device without physical access to the device or the ability to directly operate the device. In such instances, manual screening, whether in person or using a remotely-captured image, is incapable of meeting the precision and speed required to verify the integrity of the device in a reasonable time, and therefore the systems, methods, and/or apparatuses described herein may be utilized for improved analysis of a condition of a device. Similarly, users who purchase used or refurbished devices may wish to purchase insurance aftermarket, when the condition of the device is unknown to the insurance provider. The insurance provider may utilize the systems, methods, and/or apparatuses described herein to confirm the condition of the device at the time the protection is purchased, thereby minimizing loss and/or preventing fraudulent purchases of protection for devices with existing damage. Moreover, in some instances, a user may want to sell a device or trade-in a device, which may trigger the device inspection and/or integrity verification processes. Other use cases of the flexible, remote inspection and verification processes and systems described herein can be appreciated by one skilled in the art.

Embodiments of the present disclosure may provide flexible, rapid (e.g., real-time or near real-time) inspection and verification of an object using a second object (e.g., a mobile device) via the processes, systems, and computer program products described herein that provide for object inspection and verification of the integrity of the object without requiring a dedicated software application to be installed locally on one or more of the devices, without requiring direct wired or wireless communication or pairing between the devices, and/or without requiring an account or credentials to be first established. In some embodiments, one or more of the aforementioned features may be added without departing from the scope of the disclosure, but each may be omitted while maintaining sufficient security, accuracy, and speed due to the processes, systems, and computer program products described herein. In some embodiments, security may be maintained by locking, disabling, or otherwise preventing capture of an image of the first device by the second device (e.g., disabling the sensor and/or disabling the ability of the second device to store images, at least in connection with the inspection and/or verification process). In some embodiments analysis of an image of the first device by the second device or a remote system (e.g., whether or not an image is captured, causing the second device or a remote analysis system to not analyze any captured image for device inspection) may be prevented prior to verification of the identity of the first device (e.g., verification via one or more of the digital code scanning processes described herein) to maintain security. The device inspection and/or verification processes may then be used to direct (e.g., automatically or in response to a selection) various downstream processes including, but not limited to, device repair and/or recapture of one or more images (e.g., at a different distance or orientation).

It will be appreciated that reference made herein to terms such as warranty, extended warranty, insurance, insurance policy, policy, coverage, device protection plan, protection plan, and/or the like, are not intended to limit the scope of the disclosure, and that example embodiments may relate to the enrollment of mobile devices in any such aforementioned plan or similar plan to protect a mobile device against loss or may relate to other environments using the systems, methods, and/or apparatuses described herein. Similarly, any references to analyzing and/or verifying the condition of the device may relate to qualification of the mobile device for enrollment in any of the aforementioned plans or environments or any other process that may require inspection and/or integrity verification processes.. Still further, determination of the mobile device condition status may be used for other purposes.

The device-to-device imaging process and/or device-to-device imaging system disclosed herein may additionally or alternatively provide one or more other improved efficiencies over traditional image processing systems. Such improvements may include, but are not limited to; reduced processor loads for a mobile device and/or a server, such as by loading one or more lean pretrained neural networks onto the second device for efficient processing, by removing unnecessary software installation and storage steps, by handling at least a portion of certain data heavy tasks locally at the image capture device, by handling at least a portion of certain data heavy tasks via a server rather than a mobile device, by remotely controlling imaging process functionality at a mobile device, etc.; reduced computing resources for a mobile device and/or a server that cause little to no downtime for any other computing resource when modified, added, or removed, such as by removing unnecessary software installation and storage steps at a mobile device by offloading various functionalities at a server and/or another mobile device, handling at least a portion of certain data heavy tasks via a server rather than a mobile device, by remotely controlling imaging process functionality at a mobile device, etc.; holistic image processing facilitating improved processing of images, such as by providing real-time filtering of images, by utilizing image quality criteria before capturing images, etc.; improved fraud detection related to captured images, such as by performing authentication steps prior to capturing images, etc.; reduced computing resource usage for mobile devices via a web browser session, such as by removing unnecessary software installation and storage steps at a mobile device by utilizing the web browser session, etc.; improved user device experience, such as by reducing an amount of time and/or a number of interactions with a user interface to perform the device-to-device imaging process, etc.; optimized machine learning modeling associated with images, such as by retraining a machine learning model based on results of the device-to-device imaging process, etc.; and the like.

### Definitions

In some embodiments, some of the operations above may be modified or further amplified. Furthermore, in some embodiments, additional optional operations may be included. Modifications, amplifications, or additions to the operations above may be performed in any order and in any combination.

As used herein, the terms “data,” “content,” “digital content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “data packet” refers to a collection of data including data structures and/or individual data elements that is transmittable between a plurality of computing entities (e.g., mobile devices, servers, systems, and/or the like) collectively, such that the included data (e.g., data structures, data elements) remains associated therewith. The data packet is configured to store data therein with a standardized formatting, such that computing entities are able to automatically determine the type of data stored within the data packet. For example, a data packet comprise substantive data stored within a payload of the data packet that is to be passed between computing entities, as well as metadata associated with the generation of the data packet that is stored within a routing data portion of the data packet.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer may read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

The term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

The terms “user”, “client”, and/or “request source” refer to an individual or entity that is a source, and/or is associated with sources, of a request for a mobile device integrity status to be provided by a mobile device condition status system and/or any other system capable of predicting and/or modeling a condition of a mobile device. For example, a user and/or client may be the owner and/or entity of a mobile device that seeks a condition status of a mobile device based on a captured image of the mobile device.

The term “mobile device” refers to computer hardware and/or software that is configured to access a service made available by a server. The server is often (but not always) on another computer system, in which case the mobile device accesses the service by way of a network. Mobile devices may include, without limitation, smart phones, tablet computers, laptop computers, wearables, virtual reality devices, augmented reality devices, handheld gaming devices, personal computers, enterprise computers, and the like. Wearables may include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like. Mobile devices, as described herein, communicate with and otherwise access a mobile device condition status system via one or more networks. In some embodiments, the mobile device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “mobile device” may refer to computer hardware and/or software that is configured to access a component made available by a server. The server is often, but not always, on another computer system, in which case the client accesses the component by way of a network.

The term “digital code” refers to a visual data structure that encodes information. For example, the digital code may encode information in a visual machine-readable format. Additionally, the digital code may be a computer-generated code configured as a two-dimensional (2D) barcode, a matrix barcode (e.g., a 2D matrix barcode), a QR code, a linear barcode (e.g., a one-dimensional barcode), or another type of machine-readable symbol configured to encode information in a visual machine-readable format. A matrix barcode (e.g., a 2D matrix barcode) may be a particular type of digital code that encodes information in a grid format. In some embodiments, the digital code may be a visual code that encodes information in an image or another type of visual element. The encoded information may include information associated with one or more processes for providing a mobile device condition status. In some embodiments, the encoded information may include information associated with a proxy endpoint for a mobile device condition status system. In some embodiments, the encoded information may additionally or alternatively include information associated with a mobile device. In some embodiments, the encoded information may additionally or alternatively include a random passcode or other security data. In some embodiments, the encoded information may be configured based on a visual data structure format, color, size, brightness, or other visual feature of the digital code. In some embodiments, a digital code is a device identifier code that uniquely identifies a mobile device. In some embodiments, a device identifier code contains information to establish an electronic connection between a first mobile device and a second mobile device. In some embodiments, a device identifier code includes information associated with hardware or software contained in a mobile device.

The term “sequence of dynamic digital codes” refers to set of digital codes where respective digital codes are dynamically displayed one after another in a sequence. In some embodiments, a particular digital code of the sequence of dynamic digital codes may be displayed via a display screen of a mobile device for a defined period of time period of time, followed by display of no digital code for another defined period of time period, and then followed by display of another particular digital code of the sequence of dynamic digital codes via the display screen for the defined period of time period of time, etc. In some embodiments, respective digital codes of the sequence of dynamic digital codes may encode corresponding information. Additionally or alternatively, respective digital codes of the sequence of dynamic digital codes may encode one or more different types of information.

The term “mobile device condition status system” refers to a system that includes one or more computer(s) embodied in hardware, software, firmware, and/or a combination thereof to provide one or more computer-implemented processes associated with providing a mobile device condition status associated with a mobile device. In some embodiments, the mobile device condition status system includes one or more application server(s), database server(s), enterprise computing terminal(s), and/or the like that are configured to perform one or more computer-implemented processes associated with providing a mobile device condition status associated with a mobile device. Additionally or alternatively, in some embodiments, the mobile device condition status system includes one or more virtual computer(s) embodied in a software environment maintained via particular hardware, for example where the mobile device condition status system is maintained as a virtual environment on hardware of a central terminal supporting multiple software application(s). In some embodiments, the mobile device condition status system includes one or more hardware device(s) within the same physically defined space, such as a data warehouse, company headquarters, and/or the like, associated with a particular entity. Alternatively or additionally, in some embodiments, the mobile device condition status system includes one or more hardware and/or software device(s) located remotely from one another and that communicate in conjunction with one another to provide the described functionality for providing a mobile device condition status associated with a mobile device. In some embodiments, the mobile device condition status system includes and/or is communicatively coupled to one or more trained models (e.g., one or more machine learning models) utilized via one or more computer-implemented processes associated with providing a mobile device condition status associated with a mobile device. In some embodiments, the mobile device condition status system is associated with a proxy endpoint of a network.

The term “proxy endpoint” refers to a data transfer interface, for example, an Application Program Interface (API) between unconnected computing systems via a network. A proxy endpoint embodies a data transfer interface such as an API configured to enable communication between the mobile device condition status system and one or more mobile devices via the API. For example, a proxy endpoint enables data transfer of one or more data packets (comprising routing data and/or payload data) between the mobile device condition status system and one or more mobile devices. In various embodiments, a proxy endpoint is defined at least in part by a URL accessible to one or more mobile devices via one or more devices associated with the mobile device condition status system, where the URL may be utilized to direct the one or more mobile devices to a set of computer-executable instructions, a hypertext transfer protocol secure (HTTPS) connection, a secure shell file transfer protocol (SFTP) connection, and/or a web browser session associated with providing a mobile device condition status associated with a mobile device. As discussed herein, a data packet via a proxy endpoint comprises data formatted to enable and/or request usage by the one or more mobile devices and/or the mobile device condition status system to perform a desired operation and/or provide a requested data element, data structure, and/or the like. In certain embodiments the proxy endpoint enables real-time retrieval of data from the mobile device condition status system and/or the one or more mobile devices. In various embodiments, the proxy endpoint is configured to enable the mobile device condition status system to pull data from one or more mobile devices upon the workflow of a trigger event acting to inform the mobile device condition status system of the presence of data that is ready for retrieval. Further, in certain embodiments, the proxy endpoint is configured to enable the mobile device condition status system to transmit data to one or more mobile devices upon the workflow of a trigger event acting to inform the mobile device condition status system of the presence of data that is ready for transmission.

The term “image capture device” refers to a device that includes one or more image capture sensors for capturing one or more images and/or video. For example, an image capture device may be camera or another type of image capture device that is configured to capture one or more images and/or video. In some embodiments, an image capture device may be included in and/or communicatively coupled to a mobile device. For example, an image capture device may be a front facing image capture sensor (e.g., a camera) configured on the same side of the mobile device as a display screen, a rear facing image capture sensor (e.g., a camera) on a rear surface of the mobile device (e.g., on a side of the mobile device lacking a display screen), or another image capture sensor of a mobile device.

The term “electronic connection” refers to a link established for a session associated with providing a mobile device condition status for a mobile device. In some embodiments, the session may be a web browser session. In some embodiments, the electronic connection may be a connection between a first mobile device and a second mobile device to enable communication between the first mobile device and the second mobile device. For example, the electronic connection may be a connection between a first mobile device and a second mobile device to enable exchange of data between the first mobile device and the second mobile device. Additionally, the electronic connection may be established via the mobile device condition status system. For example, the mobile device condition status system may provide the electronic connection between the first mobile device and the second mobile device such that the first mobile device and the second mobile device may communicate via one or more communication channels of the mobile device condition status system. In various embodiments, the electronic connection may be a network connection. Additionally, the electronic connection may be any wired or wireless communication connection. In some embodiments, the electronic connection may be established via an API and/or a proxy endpoint associated with the mobile device condition status system. In some embodiments, the electronic connection may be established via a website portal and/or a URL accessible to the first mobile device and the second mobile device. In some embodiments, the electronic connection may be an HTTPS connection. In other embodiments, the electronic connection may be via an application portal or another type of communication channel. For example, in some embodiments, the electronic connection may be established via a software application downloaded on the first mobile device and/or the second mobile device. In another example, the electronic connection may be established via software development kit (SDK) downloaded on the first mobile device and/or the second mobile device.

The term “web browser session” refers to a particular type of electronic connection between a first mobile device and second mobile device that is enabled via a web browser. In some embodiments, a web browser session is hosted by a mobile device condition status system. In some embodiments, a web browser session enables an exchange of messages and/or data. In some embodiments, a web browser session may provide a direct connection between mobile devices. In other embodiments, a web browser session may provide an electronic connection between mobile devices through one or more intermediary devices associated with the mobile device condition status system. In some embodiments, a web browser session may be associated with a WebSocket connection.

The term “condition” refers to a condition or status of a mobile device. For example, a condition may indicate whether or not a mobile device is associated with damage. Damage may include, but is not limited to, crack(s), occlusion(s), water damage, dent(s), scratch(es), and/or any other damage associated with a mobile device. Damage may prevent one or more portions of a mobile device from operating properly. Additionally or alternatively, damage may prevent a mobile device from being insured or protected via an insurance plan, a warranty, a device protection plan, and/or another type of service plan for a mobile device. In a non-limiting example, a condition may indicate whether a crack or other damage is present on a display screen of a mobile device. In various embodiments, a condition of a mobile device may be determined based on one or more images associated with the mobile device.

The term “trained model” refers to one or more machine learning, algorithmic, and/or statistical models, or a combination thereof, for providing an inference, classification, and/or prediction associated with one or more portions of one or more computer-implemented processes associated with providing a mobile device condition status associated with a mobile device. A trained model may be a machine learning model that is trained, configured, and/or tuned for providing an inference, classification, and/or prediction associated with one or more portions of one or more computer-implemented processes associated with providing a mobile device condition status associated with a mobile device. In various embodiments, a trained model may be a mobile device presence model trained to detect whether a mobile device is present in an image, a location detection and cropping model trained to detect the location of a mobile device and optionally crop the image, a device type model trained to identify a make and/or model of a mobile device based on a location of one or more lenses, device features, and/or other markings of a mobile device in an image, a cover detection model trained to detect a cover on a mobile device present in the image, a mobile device front/rear identification model trained to determine whether an image reflects the front or rear of the device, a mobile device authenticity model trained to determine whether the image includes the mobile device from which the image was captured, an occlusion detection model trained to determine whether an object (e.g., a screen of a mobile device) in an image is occluded, a damage detection model trained to detect damage to the mobile device in the image, an image quality model trained to determine whether the image includes sufficient quality (e.g., without blurriness, etc.) for a mobile device condition status process, and/or another type of model trained for providing an inference, classification, and/or prediction associated with one or more portions of one or more computer-implemented processes associated with providing a mobile device condition status associated with a mobile device.

The term “machine learning model” refers to a data entity that describes parameters, hyper-parameters, and/or defined operations configured, trained, and/or the like to generate an output for a predictive task, a classification task, and/or a generative task using machine learning techniques. For example, a machine learning model may include one or more layers, one or more rule-based layers, one or more neural network layers, and/or one or more other types of layers that depend on trained parameters, coefficients, and/or the like. In some embodiments, machine learning model may be configured, trained, and/or the like to generate an output for a predictive task, a classification task, and/or a generative task for a predictive domain associated with providing a mobile device condition status associated with a mobile device. A machine learning model may include one or more of any type of machine learning model including one or more supervised, unsupervised, semi-supervised, reinforcement learning models, and/or the like. For instance, a machine learning model may include a supervised model that may be trained using a historical training dataset. In some examples, a machine learning model may include multiple models configured to perform one or more different stages of a classification and/or prediction process. In various embodiments, a machine learning model may be configured as a neural network model, a deep learning model, a convolutional neural network (CNN) model, a natural language processing (NLP) model, a large language model (LLM), a generative model, a transformer model, and/or another type of machine learning model. In some embodiments, a machine learning model may be designed and/or trained for a particular predictive domain associated with providing a mobile device condition status associated with a mobile device. In some embodiments, a machine learning model may be designed and/or trained to apply one or more machine learning techniques to a feature set associated with one or more images of a mobile device.

The term “request” refers to an electronic connection request to access and/or receive data associated with a mobile device and/or a mobile device condition status system. For example, a request may be a request to initiate an electronic connection between a first mobile device and a second mobile device to facilitate one or more computer-implemented processes associated with providing a mobile device condition status. In some embodiments, a request is a network request. In some embodiments, a request is a request for a mobile device condition status. For example, a request may be a request to initiate one or more computer-implemented processes associated with providing a mobile device condition status associated with a mobile device. In some embodiments, a request is a request to initiate a web browser session associated with providing a mobile device condition status associated with a mobile device.

The term “user interface” refers to a specifically structured interactive virtual environment that is configured for selective presentation of various data structures, as described herein. A user interface includes data rendered to a display screen of a mobile device that includes one or more interface elements visible to a user of the mobile device. In some embodiments, a user interface is interactable such that the use may perform various user interaction(s) with the one or more of the structured interface elements defined within the user interface, each of which may correspond to a unique functionality of the user interface. In particular, it should be appreciated that in various example contexts, a user interface provides access to particular functionality of the mobile device condition status system via one or more computing devices (e.g., initiation of one or more processes, communication with a remote processing server configured to perform particular functionality, and/or updating of renderings to a display). In some embodiments, a user interface is configured to render a data element, a data structure, and/or the like to facilitate user interaction with the rendered data. In some embodiments, a user interface is configured to render one or more digital codes such as, for example, a sequence of dynamic digital codes.

The term “server device” or “networked device” refers to computer hardware and/or software that is configured to access one or more services made available by a server. For example, in certain embodiments, the device is defined by computer hardware and/or software configured to access a service made available by the mobile device condition status system and/or is in communication with one or more networked devices of the mobile device condition status system. In various embodiments, a mobile device that is in communication with the mobile device condition status system may be provided with access to various functionalities of the mobile device condition status system by way of a network.

### Example Systems

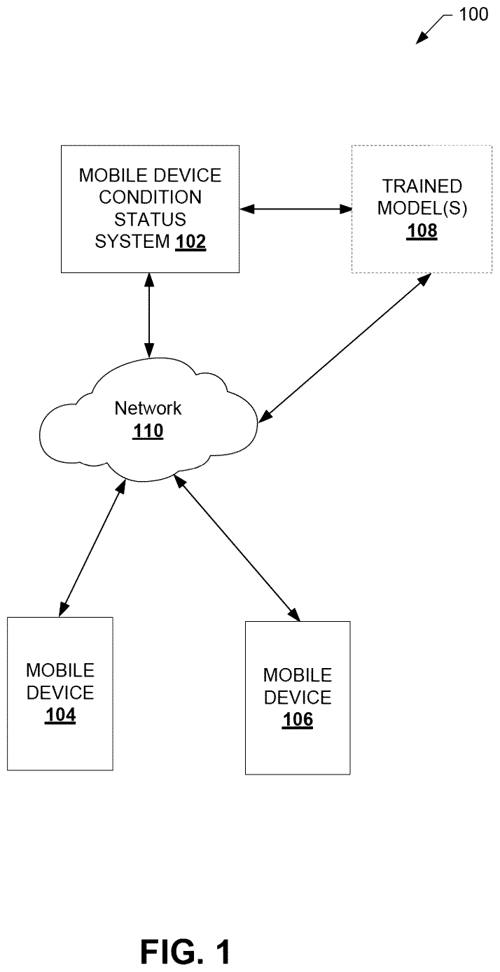

FIG. 1 illustrates a block diagram of a system that may be specially configured within which embodiments of the present disclosure may operate. Specifically, FIG. 1 illustrates an example system 100. The example system 100 includes at least a mobile device condition status system 102, a mobile device 104, and/or a mobile device 106. While two mobile devices are illustrated, it is to be understood that additional mobile devices and/or other objects (e.g., a mobile device, personal computer, television, vehicle, or the like) may be used with the various embodiments discussed herein. In one or more embodiments, the system 100 includes at least one communications network 110 that enables transmission of data between one or more subsystem(s) and/or device(s) of the system 100.

The mobile device condition status system 102 includes one or more computer(s) embodied in hardware, software, firmware, and/or a combination thereof. In some embodiments, the mobile device condition status system 102 includes one or more application server(s), database server(s), computing terminal(s), and/or the like that are configured to perform the functionality described herein. In some embodiments, the mobile device condition status system 102 embodies or includes a backend system (e.g., one or more enterprise server(s)) that are communicable over one or more network(s) (e.g., via the Internet). Additionally or alternatively, in some embodiments, the mobile device condition status system 102 includes one or more virtual computer(s) embodied in a software environment maintained via particular hardware, for example where the mobile device condition status system 102 is maintained as a virtual environment on hardware of a central terminal supporting multiple software application(s). In some embodiments, the mobile device condition status system 102 includes one or more hardware device(s) within the same physically defined space, such as a data warehouse, company headquarters, and/or the like associated with a particular entity. Alternatively or additionally, in some embodiments, the mobile device condition status system 102 includes one or more hardware and/or software device(s) located remotely from one another and that communicate in conjunction with one another to provide the described functionality, for example embodied by one or more cloud computing system(s).

In some embodiments, the mobile device condition status system 102 includes a plurality of sub-services that each support a portion of the functionality performed by the mobile device condition status system 102. In some embodiments, the plurality of sub-services may each be embodied by different hardware, software, firmware, and/or any combination thereof. Alternatively or additionally, in some embodiments, one or more of the sub-services share particular hardware, software, firmware, and/or any combination thereof. For example, in some embodiments, the mobile device condition status system 102 embody specially-configured software applications executed on shared hardware.

In some embodiments, the mobile device condition status system 102 supports a mobile device condition status process for providing a mobile device condition status associated with the mobile device 104 or the mobile device 106. In some embodiments, the mobile device condition status system 102 supports functionality for managing a web browser session associated with the mobile device 104 and/or the mobile device 106. In some embodiments, the mobile device condition status system 102 supports functionality for managing a software application and/or SDK downloaded on the mobile device 104 and/or the mobile device 106. In some embodiments, the mobile device condition status system 102 supports functionality for rendering one or more user interfaces via a display screen of the mobile device 104 and/or the mobile device 106 to facilitate the mobile device condition status process. For example, in some embodiments, the mobile device condition status system 102 supports functionality for providing and/or detecting one or more digital codes displayed via the mobile device 104 and/or the mobile device 106. In some embodiments, the mobile device condition status system 102 additionally or alternatively supports functionality for causing an image capture device of the mobile device 104 and/or the mobile device 106 to capture one or more images. In some embodiments, the mobile device condition status system 102 additionally or alternatively supports functionality for analyzing the one or more images. In some embodiments, the mobile device 106 may capture the one or more images via an image capture device of the mobile device 106 based on a determination that a digital code transferred from the mobile device condition status system 102 and displayed via a screen of the mobile device 104 corresponds to a digital code detected by the mobile device 106.

In some embodiments, the mobile device condition status system 102 utilizes one or more trained models 108 to analyze the one or more images. For example, the one or more trained models 108 may be respectively trained, configured, and/or tuned for providing an inference, classification, and/or prediction associated with one or more portions of the mobile device condition status process. In some embodiments, the one or more trained models 108 may be one or more machine learning models. For example, the one or more trained models 108 may be one or more neural network models. In some embodiments, the one or more trained models 108 may be operated remotely via the communications network 110. For example, the mobile device 104, the mobile device 106, and/or the mobile device condition status system 102 may utilize the one or more trained models 108 via the communications network 110. In other embodiments, the one or more trained models 108 may be operated locally on the mobile device 104 and/or the mobile device 106. In other embodiments, a portion of the one or more trained models 108 may be operated remotely via the communications network 110 and another portion of the one or more trained models 108 may be operated locally on the mobile device 104 and/or the mobile device 106.

In various embodiments, the one or more trained models 108 may include a mobile device presence model trained to detect whether a mobile device is present in an image, a location detection and cropping model trained to detect the location of a mobile device and optionally crop the image, a device type model trained to identify a make and/or model of a mobile device, a cover detection model trained to detect a cover on a mobile device present in the image, a mobile device front/rear identification model trained to determine whether an image reflects the front or rear of the device, a mobile device authenticity model trained to determine whether the image includes the mobile device from which the image was captured, an occlusion detection model trained to determine whether an object in an image is occluded (e.g., whether one or more portions of a screen of a mobile device is obscured in an image, whether a partial screen is detected in an image instead of an entire screen, whether a finger or other object is obscuring a portion of a screen, etc.), a damage detection model trained to detect damage to the mobile device in the image, an image quality model trained to determine whether the image includes sufficient quality (e.g., without blurriness, etc.) for a mobile device condition status process, and/or another type of model trained for providing an inference, classification, and/or prediction associated with the mobile device condition status process.

In some embodiments, the mobile device 104 embodies a user device and/or end terminal accessible by a user to initiate functionality via the mobile device condition status system 102. For example, in some embodiments, a user enters authentication credentials via the mobile device 104 that are validated to initiate an authenticated session associated with the mobile device condition status system 102, such that the user may utilize the mobile device 104 to access functionality of the mobile device condition status system 102. In some embodiments, the authenticated session may be initiated via a particular digital code that is captured via an image capture device of the mobile device 104. The mobile device 104, in some embodiments, is utilized to initiate one or more indication(s) of a trusted processing request. Additionally or alternatively, in some embodiments, the mobile device 104 is utilized to render user interface(s) that provide details associated with a mobile device condition status process for providing a mobile device condition status associated with the mobile device 104. In some embodiments, the mobile device 104 operates as a front-end or user-facing application for accessing such functionality of the mobile device condition status system 102.

In some embodiments, the mobile device 104 supports a computer-implemented process for managing a mobile device condition status associated with the mobile device 104. For example, in some embodiments, the mobile device 104 supports a computer-implemented process that is controllable via instructions from a different entity, such as the mobile device condition status system 102, to render one or more user interfaces via a display screen of the mobile device 104. Various embodiments of the session between mobile devices may further allow one or both of the respective devices to control or cause display of information on the other. In some examples, the display screen of the mobile device 104 may render one or more digital codes to facilitate the mobile device condition status process. In some embodiments, the mobile device 104 supports automatically receiving and/or transmitting data transmissions, for example embodied by API request(s), procedure call(s), and/or other digital data transfers, that embody a set of computer-executable instructions associated with the mobile device condition status process.

In some embodiments, the mobile device 106 embodies a user device and/or end terminal accessible by a user to initiate functionality via the mobile device condition status system 102. In some embodiments, the authenticated session may be initiated via a particular digital code that is captured via an image capture device of the mobile device 106. The mobile device 106, in some embodiments, is utilized to initiate one or more indication(s) of a trusted processing request. Additionally or alternatively, in some embodiments, the mobile device 106 is utilized to render user interface(s) that provide details associated with a mobile device condition status process for providing a mobile device condition status associated with the mobile device 104. In some embodiments, the mobile device 106 operates as a front-end or user-facing application for accessing such functionality of the mobile device condition status system 102.

In some embodiments, the mobile device 106 supports a computer-implemented process for managing a mobile device condition status associated with the mobile device 104. For example, in some embodiments, the mobile device 106 supports a computer-implemented process that is at least partially controllable via instructions from a different entity such as the mobile device condition status system 102 to enable detection of one or more digital codes rendered via the display screen of the mobile device 104. Additionally or alternatively, the mobile device 106 supports a computer-implemented process that is controllable via instructions from a different entity such as the mobile device condition status system 102 to enable capture of one or more images of the mobile device 104. In some embodiments, the mobile device 106 may utilize one or more digital codes provided by the mobile device condition status system 102 to facilitate capturing of one or more images of the mobile device 104. For example, in response to a determination by the mobile device 106 that one or more digital codes displayed via the mobile device 104 matches one or more digital codes provided by the mobile device condition status system 102, the mobile device 106 may capture one or more images of the mobile device 104. In some embodiments, the mobile device 106 supports automatically receiving and/or transmitting data transmissions, for example embodied by API request(s), procedure call(s), and/or other digital data transfers, that embody a set of computer-executable instructions associated with the mobile device condition status process.

In some embodiments, the mobile device 104 and the mobile device 106 are controlled by the same entity such as, for example, the mobile device condition status system 102. For example, the mobile device condition status system 102 may establish communication with the mobile device 104 and/or the mobile device 106 via one or more digital codes and/or user interactions with respect to a screen of the mobile device 104 and/or the mobile device 106 to authorize remote control of the mobile device 104 and/or the mobile device 106. In other embodiments, different entities control each of the mobile device 104 and the mobile device 106 and/or one or more of the mobile devices directs at least a portion of the processes described herein. It will be appreciated that the mobile device 104 and mobile device 106 may communicate via a corresponding communications network. In some embodiments, one or more other mobile devices may be in communication with the other various computing systems of the system 100.

The communications network 110 is configurable to be embodied in any of a myriad of network configurations. In some embodiments, the communications network 110 embodies a public network (e.g., the Internet). In some embodiments, the communications network 110 embodies a private network (e.g., an internal, localized, or closed-off network between particular devices). In some other embodiments, the communications network 110 embodies a hybrid network (e.g., a network enabling internal communication between particular connected devices and external communication with other devices). The communications network 110 in some embodiments includes one or more base station(s), relay(s), router(s), switch(es), cell tower(s), communications cable(s) and/or associated routing station(s), and/or the like. In some embodiments, the communications network 110 includes one or more computing device(s) controlled by individual entities (e.g., an entity-owner router and/or modem) and/or one or more external utility devices (e.g., Internet service provider communication tower(s) and/or other device(s)).

The computing devices of the system 100 may each communicate in whole or in part over a portion of one or more communication network(s), such as the communications network 110. For example, each of the components of the system 100 may be communicatively coupled to transmit data to and/or receive data from one another over the same and/or different wireless or wired networks embodying the communications network 110. Non-limiting examples of network configuration(s) for the communications network 110 include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network(s), the various embodiments are not limited to this particular architecture. In other embodiments, one or more computing entities share one or more components, hardware, and/or the like, or otherwise are embodied by a single computing device such that connection(s) between the computing entities are altered and/or rendered unnecessary. Alternatively or additionally still, in some embodiments the communications network 110 enables communication to one or more other computing device(s) not depicted, for example client device(s) for accessing functionality of any of the subsystems therein via native and/or web-based application(s), and/or the like.

### Example Apparatus

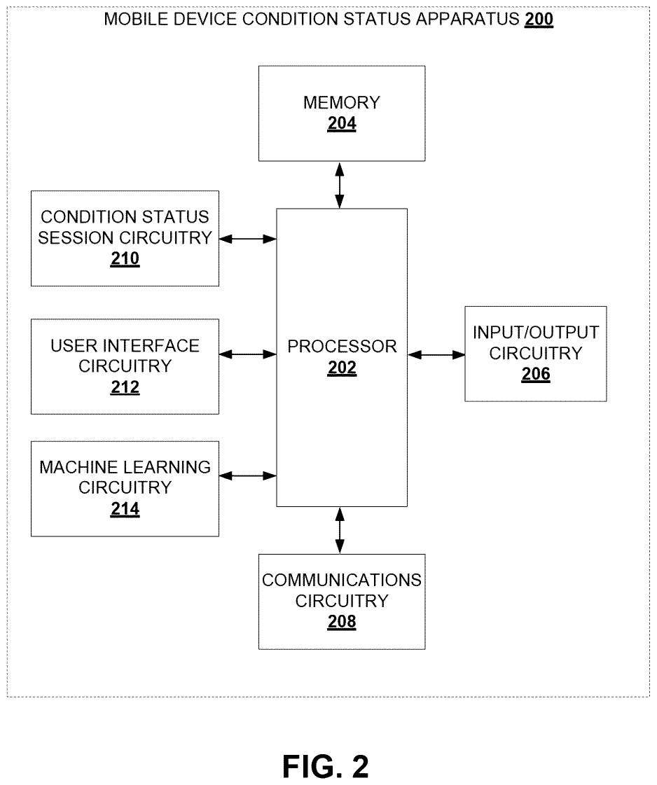

FIG. 2 illustrates a block diagram of an example apparatus that may be specially configured in accordance with at least one example embodiment of the present disclosure. Specifically, FIG. 2 illustrates an example mobile device condition status apparatus 200 (“apparatus 200”) specially configured in accordance with at least one example embodiment of the present disclosure. In some embodiments, the mobile device condition status system 102, and/or a portion thereof, is embodied by one or more system(s), device(s), and/or the like, such as the mobile device condition status apparatus 200 as depicted and described in FIG. 2. The mobile device condition status apparatus 200 includes processor 202, memory 204, input/output circuitry 206, communications circuitry 208, condition status session circuitry 210, user interface circuitry 212, and/or machine learning circuitry 214. In some embodiments, the mobile device condition status apparatus 200 is configured, using one or more of the sets of circuitry 202, 204, 206, 208, 210, 212, and/or 214, to execute and perform one or more of the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, modeling, and/or similar terms used herein interchangeably. In one embodiment, these functions, operations, and/or processes may be performed on data, content, information, and/or similar terms used herein interchangeably. In this regard, the mobile device condition status apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the mobile device condition status apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the mobile device condition status apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the mobile device condition status apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the mobile device condition status apparatus 200, and/or one or more remote or “cloud” processor(s) external to the mobile device condition status apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. In some embodiments, the processor 202 includes or is embodied by a CPU, microprocessor, and/or the like that executes computer-coded instructions, for example stored via the non-transitory memory 204.

In some embodiments, the mobile device condition status apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user. In some embodiments, the input/output circuitry 206 includes hardware, software, firmware, and/or a combination thereof, that facilitates simultaneously display of particular data via a plurality of different devices.

In some embodiments, the mobile device condition status apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the mobile device condition status apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from a client device, capture device, and/or other external computing device in communication with the mobile device condition status apparatus 200.

In some embodiments, the mobile device condition status apparatus 200 includes condition status session circuitry 210. The condition status session circuitry 210 includes hardware, software, firmware, and/or a combination thereof, that supports various functionality associated with managing a mobile device condition status session for providing a mobile device condition status associated with the mobile device 104 or the mobile device 106. In some embodiments, the mobile device condition status session may be a web browser session for providing a mobile device condition status associated with the mobile device 104 or the mobile device 106. For example, in some embodiments, the condition status session circuitry 210 includes hardware, software, firmware, and/or a combination thereof, that detects, via an image capture device of the mobile device 106, one or more digital codes displayed via a screen of the mobile device 104. The condition status session circuitry 210 additionally or alternatively includes hardware, software, firmware, and/or a combination thereof, that processes the one or more digital codes to initiate an electronic connection between the mobile device 104 and the mobile device 106. The condition status session circuitry 210 additionally or alternatively includes hardware, software, firmware, and/or a combination thereof, that causes the mobile device 106 to capture at least one image of the mobile device 104 via the image capture device of the mobile device 106.

Additionally or alternatively, in some embodiments, the condition status session circuitry 210 includes hardware, software, firmware, and/or a combination thereof, that enables access to one or more API(s), FTP connection(s), HTTPS connection(s), SFTP connection(s), and/or the like to securely monitor, acquire, receive, retrieve, transmit and/or otherwise identify electronic data from one or more systems (e.g., the mobile device 104 and/or the mobile device 106) external from the mobile device condition status apparatus 200. In some embodiments, the condition status session circuitry 210 includes a separate processor, specially configured field programmable gate array (FPGA), or a specially programmed application specific integrated circuit (ASIC).

In some embodiments, the mobile device condition status apparatus 200 includes user interface circuitry 212. The user interface circuitry 212 includes hardware, software, firmware, and/or a combination thereof, that supports various functionality associated with automatically managing one or more user interfaces associated with the mobile device condition status session for providing a mobile device condition status associated with the mobile device 104 or the mobile device 106. For example, in some embodiments, the user interface circuitry 212 includes hardware, software, firmware, and/or a combination thereof, that renders one or more digital codes via a display (e.g., a display screen) of the mobile device 104. In some embodiments, the user interface circuitry 212 includes a separate processor, specially configured FPGA, or a specially programmed ASIC.

In some embodiments, the mobile device condition status apparatus 200 includes machine learning circuitry 214. The machine learning circuitry 214 includes hardware, software, firmware, and/or a combination thereof, that supports various functionality associated with the one or more trained models 108. For example, in some embodiments, the machine learning circuitry 214 includes hardware, software, firmware, and/or a combination thereof, that analyzes at least one image of the mobile device 104 by utilizing the one or more trained models 108 to determine a condition associated with the mobile device 104. In some embodiments, the machine learning circuitry 214 includes a separate processor, specially configured FPGA, or a specially programmed ASIC. In some embodiments, the machine learning circuitry 214 includes hardware, software, firmware, and/or a combination thereof, that enables local execution of the one or more trained models 108 via a mobile device (e.g., the mobile device 104 and/or the mobile device 106). As such, in some embodiments, the machine learning circuitry 214 can be circuitry capable of executing a trained model with or without utilizing dedicated and/or pre-installed machine learning hardware.

Additionally or alternatively, in some embodiments, two or more of the sets of circuitries 202-214 are combinable. Alternatively or additionally, in some embodiments, one or more of the sets of circuitry perform some or all of the functionality described associated with another component. For example, in some embodiments, two or more of the sets of circuitry 202-214 are combined into a single module embodied in hardware, software, firmware, and/or a combination thereof. Similarly, in some embodiments, one or more of the sets of circuitry, for example the condition status session circuitry 210, user interface circuitry 212, and/or machine learning circuitry 214, is/are combined with the processor 202, such that the processor 202 performs one or more of the operations described above with respect to each of these sets of circuitry 210-214.

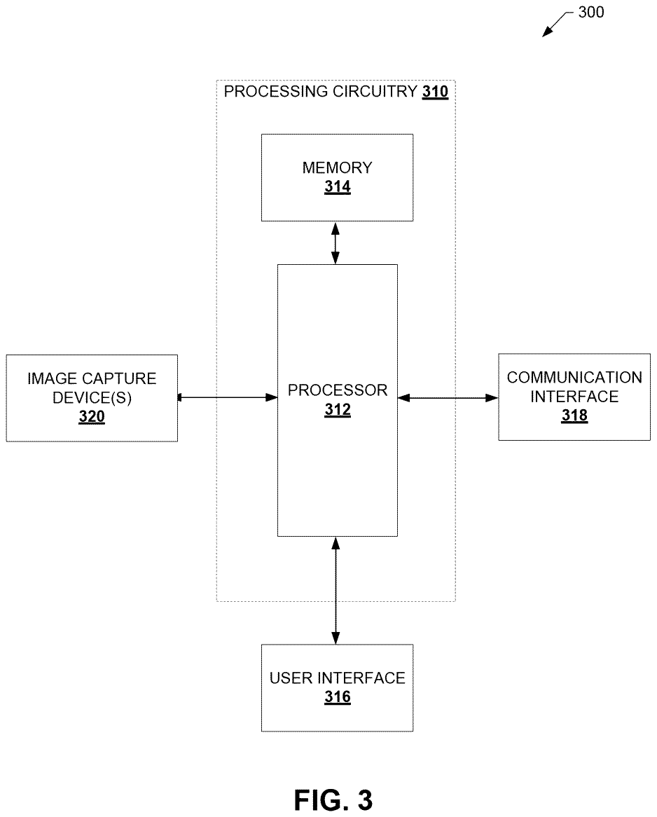

FIG. 3 illustrates a block diagram of an example apparatus 300 in accordance with one or more embodiments of the present disclosure. The apparatus 300 is a computing device(s) configured for implementing the mobile device 104 or the mobile device 106, according to one or more embodiments. For example, the apparatus 300 may at least partially or wholly embody the mobile device 104 or the mobile device 106. It should be noted that the components, devices, and elements illustrated in and described with respect to FIG. 3 may not be mandatory and thus some may be omitted in certain embodiments. Additionally, some embodiments may include further or different components, devices, or elements beyond those illustrated in and described with respect to FIG. 3. By way of example, while mobile devices, such as smart phones, are described in some embodiments herein, some examples of the first object may include any device having a screen and capable of displaying a code or other visual data (e.g., an image) and communicating with one or more other devices/systems, such as the second device and/or mobile device condition status system, and some examples of the second object may include any device capable of capturing an image of the first device and communicating with one or more other devices/systems, such as the first device and/or mobile device condition status system.

The apparatus 300 includes processing circuitry 310, which may be configured to perform actions in accordance with one or more example embodiments disclosed herein. In this regard, the processing circuitry 310 may be configured to perform and/or control performance of one or more functionalities of the apparatus 300 in accordance with various example embodiments. The processing circuitry 310 may be configured to perform data processing, application execution, and/or other processing and management services according to one or more example embodiments. In some embodiments, the apparatus 300, or a portion(s) or component(s) thereof, such as the processing circuitry 310, may be embodied as or comprise a circuit chip. The circuit chip may constitute means for performing one or more operations for providing the functionalities described herein.

In some example embodiments, the processing circuitry 310 may include a processor 312, and in some embodiments, such as that illustrated in FIG. 3, may further include memory 314. The processing circuitry 310 may be in communication with or otherwise control a user interface 316, and/or a communication interface 318. As such, the processing circuitry 310, such as that included in the mobile device 104, the mobile device 106, and/or the apparatus 300 may be embodied as a circuit chip (e.g., an integrated circuit chip) configured (e.g., with hardware, software, or a combination of hardware and software) to perform operations described herein.

The processor 312 may be embodied in a number of different ways. For example, the processor 312 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 312 may comprise a plurality of processors. The plurality of processors may be in operative communication with each other and may be collectively configured to perform one or more functionalities of the apparatus 300 as described herein. The plurality of processors may be embodied on a single computing device or distributed across a plurality of computing devices collectively configured to function as the mobile device 104 and/or the mobile device 106. In some example embodiments, the processor 312 may be configured to execute instructions stored in the memory 314 or otherwise accessible to the processor 312. As such, whether configured by hardware or by a combination of hardware and software, the processor 312 may represent an entity (e.g., physically embodied in circuitry in the form of processing circuitry 310) capable of performing operations according to embodiments of the present invention while configured accordingly. Thus, for example, when the processor 312 is embodied as an ASIC, FPGA, or the like, the processor 312 may be specifically configured hardware for conducting the operations described herein. As another example, when the processor 312 is embodied as an executor of software instructions, the instructions may specifically configure the processor 312 to perform one or more operations described herein.

In some example embodiments, the memory 314 may include one or more non-transitory memory devices such as, for example, volatile and/or non-volatile memory that may be either fixed or removable. In this regard, the memory 314 may comprise a non-transitory computer-readable storage medium. It will be appreciated that while the memory 314 is illustrated as a single memory, the memory 314 may comprise a plurality of memories. The plurality of memories may be embodied on a single computing device or may be distributed across a plurality of computing devices. The memory 314 may be configured to store information, data, applications, computer program code, instructions and/or the like for enabling the apparatus 300 to carry out various functions in accordance with one or more example embodiments. For example, when the apparatus 300 is implemented as the mobile device 104 or the mobile device 106, the memory 314 may be configured to store computer program code for performing corresponding functions thereof, as described herein according to example embodiments.

Still further, the memory 314 may be configured to store the model(s), and/or training images used to train the model(s) to predict certain pertinent information in subsequently received images. The memory 314 may be further configured to buffer input data for processing by the processor 312. Additionally or alternatively, the memory 314 may be configured to store instructions for execution by the processor 312. In some embodiments, the memory 314 may include one or more databases that may store a variety of files, contents, or data sets. Among the contents of the memory 314, applications may be stored for execution by the processor 312 to carry out the functionality associated with each respective application. In some cases, the memory 314 may be in communication with one or more of the processor 312, user interface 316, and/or communication interface 318, for passing information among components of the apparatus 300.

The user interface 316 may be in communication with the processing circuitry 310 to receive user input at the user interface 316 and/or to provide an audible, visual, mechanical, or other output to the user. As such, the user interface 316 may include, for example, a keyboard, a mouse, a display, a touch screen display, a microphone, a speaker, and/or other input/output mechanisms. For example, in embodiments in which the apparatus 300 is implemented as the mobile device 104, the user interface 316 may, in some example embodiments, provide means to display instructions for capturing images. In embodiments, the user interface 316 may render one or more digital codes to facilitate a mobile device condition status session. In embodiments, the user interface 316 may provide means for a user to capture and/or review one or more images of the mobile device 104.

The communication interface 318 may include one or more interface mechanisms for enabling communication with other devices and/or networks. In some cases, the communication interface 318 may be any means such as a device or circuitry embodied in either hardware, or a combination of hardware and software that is configured to receive and/or transmit data from/to a network and/or any other device or module in communication with the processing circuitry 310. By way of example, the communication interface 318 may be configured to enable communication amongst any of the mobile device condition status system 102, the mobile device condition status apparatus 200, and/or the apparatus 300 over a network, such as the communications network 110. Accordingly, the communication interface 318 may, for example, include supporting hardware and/or software for enabling wireless and/or wireline communications via cable, digital subscriber line (DSL), universal serial bus (USB), Ethernet, or other methods.

The apparatus 300 may include one or more image capture devices 320, such as when the apparatus 300 is embodied by the mobile device 104 or the mobile device 106. An image capture device of the one or more image capture devices 320 may be an image capture sensor, such as a camera or other image capture device, configured to capture images and/or record video from the mobile device 104. The one or more image capture devices 320 may include a front facing image capture sensor (e.g., camera) configured on the same side of the device as a display screen, and/or a rear facing image capture sensor (e.g., camera) on the rear surface of the device (e.g., on a side of the device lacking a display screen). In some embodiments, the mobile device 104 and/or the mobile device 106 may include both a front facing and rear facing image capture sensors, and in some embodiments, the mobile device 104 and/or the mobile device 106 may include only one of a front facing image capture sensor or rear facing image capture sensor. In some embodiments, any number of the one or more image capture devices 320 may be present on the apparatus 300 (e.g., the mobile device 104 and/or the mobile device 106), such as a camera built-in to the apparatus, attached of the apparatus, or otherwise associated with the apparatus. In some embodiments, one or more of the image capture devices 320 may be present on a device that is distinct from the apparatus 300 (e.g., the mobile device 104 and/or the mobile device 106). For example, an image capture device 320 may be a camera (e.g. a webcam) of a laptop, computer, tablet, or other device that is different than the apparatus 300 (e.g., the mobile device 104 and/or the mobile device 106).

### Example System for a Mobile Device Condition Status Session

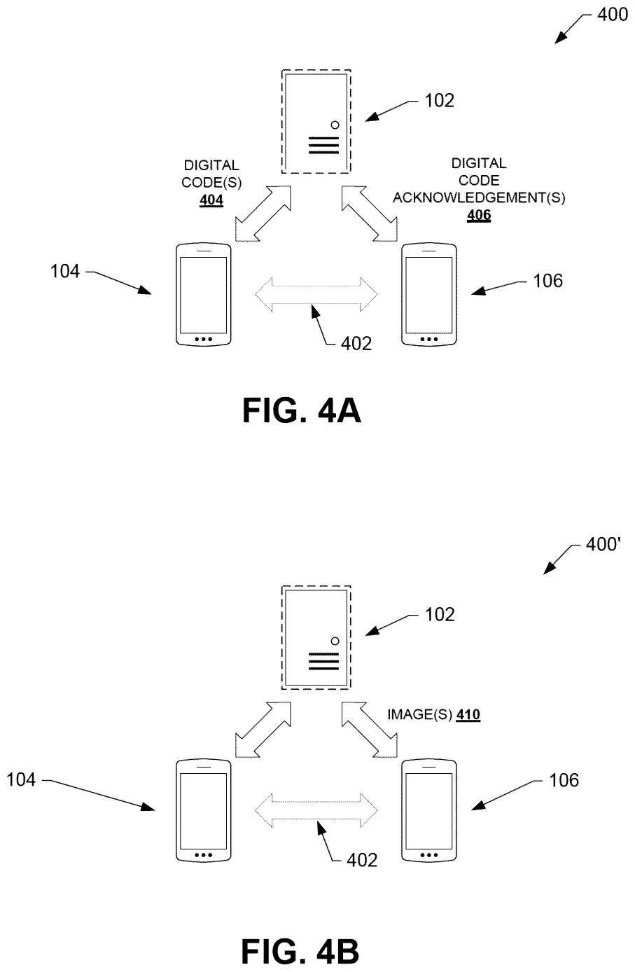

FIG. 4A illustrates an example system 400 in accordance with one or more embodiments of the present disclosure. The system 400 includes the mobile device condition status system 102, the mobile device 104, and the mobile device 106. With the system 400, the mobile device 104 may be communicatively coupled to the mobile device condition status system 102 via the communications network 110. Additionally, the mobile device 106 may be communicatively coupled to the mobile device condition status system 102 via the communications network 110. Additionally, the mobile device condition status system 102 may provide an electronic connection 402 between the mobile device 104 and the mobile device 106 to facilitate providing an electronic session via the mobile device condition status system 102. The electronic connection 402 may be provided via the communications network 110. Additionally, the electronic connection 402 may provide various trigger commands for the mobile device 104 and/or the mobile device 106 to enable providing a mobile device condition status associated with the mobile device 104 via the mobile device condition status system 102.

In some embodiments, the mobile device condition status system 102 provides or otherwise facilitates a web browser session associated with the mobile device 104 and the mobile device 106 via the electronic connection 402 (e.g., an HTTPS connection between the first mobile device 104 and the second mobile device 106). In some embodiments, the electronic connection 402 is an application session associated with a software application and/or SDK downloaded on the mobile device 104 and/or the mobile device 106. In some embodiments, the electronic connection 402 is a virtual connection provided via the mobile device condition status system 102. For example, the mobile device condition status system 102 may establish a virtual connection between the mobile device 104 and the mobile device 106 such that the mobile device 104 and the mobile device 106 communicate via the mobile device condition status system 102. In some embodiments, the virtual connection between the mobile device 104 and the mobile device 106 utilizes a client-server communication protocol (e.g., a HTTPS communication protocol, a WebSocket communication protocol, etc.) to enable real-time data transfer between the mobile device 104, the mobile device condition status system 102, and/or the mobile device 106 via the communications network 110. For example, network connection points may be exchanged between the mobile device 104, the mobile device condition status system 102, and/or the mobile device 106 via a digital code displayed via a screen of the mobile device 104 and scanned via an image capture device of the mobile device 106 to enable communication between the mobile device 104 and the mobile device 106 via the mobile device condition status system 102. As such, in some embodiments, the mobile device condition status system 102 may act as an intermediary system between the mobile device 104 and the mobile device 106.

In some embodiments, the mobile device condition status system 102 transmits one or more digital codes 404 to the mobile device 104 for display via a screen of the mobile device 104 to facilitate establishing the electronic connection 402 and/or performing the electronic session after establishing the electronic connection 402. In some embodiments, a dedicated application operating on the first mobile device 104 may be instructed (e.g., by internal function or the mobile device condition status system 102) to display the code. In some embodiments, prior to establishing the electronic connection 402 (e.g., a virtual connection between mobile devices), the mobile device condition status system 102 may detect, via an image capture device (e.g., the one or more image capture devices 320) of the mobile device 106, a first digital code of the one or more digital codes 404 displayed via the screen of the mobile device 104. Additionally, the mobile device condition status system 102 may initiate the electronic connection 402 (e.g., the web browser session between the mobile device 106 and one or more server devices of the mobile device condition status system 102) based on the first digital code. For example, the image capture device of the mobile device 106 may scan the first digital code displayed via the screen of the mobile device 104. The mobile device 106 may then transmit a digital code acknowledgment (e.g., one or more digital code acknowledgements 406) to the mobile device condition status system 102 to initiate the web browser session. In some embodiments, the second mobile device 106 may function entirely using the web browser session without requiring login credentials or dedicated applications. In response to the web browser session being initiated, the mobile device condition status system 102 may transmit one or more second digital codes of the one or more digital codes 404 to the mobile device 104 for display via the screen of the mobile device 104. For example, response to the web browser session being initiated, the mobile device condition status system 102 may transmit a sequence of dynamic digital codes to the mobile device 104 for display via the screen of the mobile device 104. In some embodiments, the mobile device 106 may then transmit a different digital code acknowledgment related to one or more second digital codes (e.g., a different digital code acknowledgment of the one or more digital code acknowledgements 406) to the mobile device condition status system 102 to acknowledge successful completion of a fraud detection process associated with the mobile device 104. For example, the mobile device 106 may perform the fraud detection process by comparing the one or more second digital codes to one or more defined digital codes associated with the web browser session. The one or more defined digital codes may correspond to at least a portion of the one or more digital codes 404 transmitted to the mobile device 104. In some embodiments, a single digital code or a single sequence of digital codes may be used for the function of both the first digital code and the second digital code(s).

FIG. 4B illustrates an example system 400′ in accordance with one or more embodiments of the present disclosure. The system 400′ includes the mobile device condition status system 102, the mobile device 104, and the mobile device 106. Additionally, the system 400′ may illustrate one or more additional or alternate embodiments as compared to the system 400. For example, the system 400 may correspond to a device authentication process and the system 400′ may correspond to a mobile device condition status process performed after the device authentication process. The mobile device condition status process associated with the system 400′ may include, for example, capturing and/or analyzing an image of the mobile device 104 to determine a mobile device condition status associated with the mobile device 104. Additionally, the mobile device condition status process associated with the system 400′ may be performed in real-time or approximately in real-time as compared to the device authentication process associated with the system 400. For example, the mobile device condition status process associated with the system 400′ may be triggered after completion of the device authentication process associated with the system 400. In some embodiments, in response to a determination by the mobile device 106 that the one or more second digital codes correspond to the one or more defined digital codes, the mobile device 106 may capture at least one image 410 of the mobile device 104 via an image capture device (e.g., the one or more image capture devices 320) of the mobile device 106. In some embodiments, the mobile device 106 may be configured to programmatically decide whether to capture an image of the mobile device 104 based on the digital codes it receives from the mobile device condition status system 102 and a comparison with what it sees on the screen of the mobile device 104. For example, the mobile device condition status system 102 may transmit one or more codes to the second mobile device 106, which the mobile device 106 then may use to search the screen of the first mobile device 104. In some embodiments, the second mobile device 106 may capture an image of the first mobile device 104 after this expected code is detected, which may reduce the bandwidth needs between the mobile devices 104, 106 and the mobile device condition status system 102 because a streaming video or other heavy data usage is not needed. The at least one image 410 may capture a screen of the mobile device 104 (e.g., without display of a digital code via the screen of the mobile device 104), a body portion of the mobile device 104, and/or one or more other portions of the mobile device 104. In some embodiments, multiple image capture and analysis processes may be used (e.g., a first analysis of the front, screen side of the first device and a second analysis of the rear side of the first device).

In some embodiments, a notification may be displayed via the mobile device 106 to align a field of view of the image capture device of the mobile device 106 with respect to the mobile device 104. In some embodiments, after a first determination that a digital code displayed via the mobile device 104 matches a digital code provided by the mobile device condition status system 102, the image capture device of the mobile device 106 may capture the at least one image 410 of the mobile device 104 in response to a second determination that the field of view satisfies alignment criteria with respect to a bounding box associated with the mobile device 104. In some embodiments, the mobile device condition status system 102 may control one or more image capture settings associated with the image capture device of the mobile device 106 in real-time or approximately in real-time during the mobile device condition status session.

In some embodiments, the one or more second digital codes may include metadata associated with the mobile device 104 and/or may be unique to the mobile device 104. Additionally, the mobile device 106 may determine whether a field of view of the image capture device of the mobile device 106 includes the mobile device 104 based on the metadata associated with the one or more second digital codes. Accordingly, the image capture device of the mobile device 106 may capture the at least one image 410 of the mobile device 104 in response to a determination that the field of view of the image capture device of the mobile device 106 includes the mobile device 104. In each of the various image capture processes disclosed herein, the second mobile device 106 may be configured to capture one or more of the images automatically in response to predefined trigger conditions (e.g., alignment of a field of view, recognition of the first mobile device, etc.). Alternatively, in some embodiments, a trigger signal may be sent to the second mobile device 106 from the mobile device condition status system 102 and/or the first mobile device 104 to cause to capturing of the one or more of the images. In some embodiments, the first mobile device 104 may control at least some of the functions of second mobile device 106 (e.g., image capture triggers) via the session. The pre-image-analysis processes described herein (e.g., alignment, bounding, field of view, etc.) may be performed locally on the second device, such as by one or more locally instantiated trained model(s) (e.g., neural network(s), etc.) in a single step or in multiple steps. Local processing may increase privacy and security while also reducing the network bandwidth requirements and speeding the analysis. In some embodiments, one or more of the processes may be omitted. In some embodiments, one or more portions of the pre-image-analysis processes described herein may additionally or alternatively be performed remotely from the second device, such as by the mobile device condition status system 102.

In some embodiments, the mobile device 106 may transmit the at least one image 410 to the mobile device condition status system 102 to cause analysis of the at least one image 410 and/or to determine a condition associated with the mobile device 104. In some embodiments, the mobile device condition status system 102 supports functionality for analyzing the at least one image 410. In some embodiments, the mobile device condition status system 102 may utilize the one or more trained models 108 to analyze the at least one image 410 and/or to determine a condition associated with the mobile device 104. In some embodiments, the mobile device condition status system 102 may utilize the one or more trained models 108 in real-time or approximately in real-time with respect to the capture of the at least one image 410.

In some embodiments, a first trained model of the one or more trained models 108 may be executed locally on the mobile device 106 to render a bounding box via a user interface of the mobile device 106 to facilitate capturing the at least one image 410 of the mobile device 104 via an image capture device (e.g., the one or more image capture devices 320) of the mobile device 106. Additionally, a second trained model of the one or more trained models 108 may be executed remotely via the communications network 110 (e.g., rather than being executed locally on the mobile device 106) to cause analysis of the at least one image 410 and/or to determine a condition associated with the mobile device 104 via the second trained model.

In some embodiments, the one or more trained models 108 may be one or more neural network models. The term “neural network model” refers to a data entity that describes parameters, hyper-parameters, and/or defined operations configured, trained, and/or the like to generate an output for a predictive task and/or a classification task using one or more neural network layers of a neural network. For example, a neural network model may include one or more neural network layers that depend on trained parameters, weights, coefficients, and/or the like. Additionally, a neural network model may include a set of neural network tokens configured for a predictive task and/or a classification task. In some embodiments, a neural network model may be configured as a deep learning model, a convolutional neural network (CNN) model, an artificial neural network (ANN) model, a simulated neural network (SNN) model, and/or another type of neural network model.

In an embodiment, a neural network model may be trained to generate a bounding box for rendering via a user interface of the mobile device 106 to facilitate capturing the at least one image 410 of the mobile device 104 via an image capture device (e.g., the one or more image capture devices 320) of the mobile device 106. In another embodiment, a neural network model may be trained to analyze the at least one image 410 and/or to determine a condition associated with the mobile device 104. In yet another embodiment, a neural network model may be trained for image processing (e.g., image pre-processing and/or image post-processing) associated with the at least one image 410. In yet another embodiment, a neural network model may be trained to determine whether the at least one image 410 is captured with sufficient quality to determine a condition associated with the mobile device 104. In yet another embodiment, a neural network model may be trained for occlusion detection based on the at least one image 410. However, it is to be appreciated that a neural network model may be trained for one or more other tasks associated with one or more processes for determining a mobile device condition status of a mobile device.

In some embodiments, a neural network model may be pre-trained and transmitted to the mobile device 106 for local operation via a web browser session that is hosted by the mobile device condition status system 102. For example, a neural network model trained to generate a bounding box and/or trained for image processing may be transmitted to the mobile device 106 for local operation via a web browser session that is hosted by the mobile device condition status system 102. In some embodiments, a neural network model may be pre-trained and remotely executed via the communications network 110. For example, a neural network model trained to determine a condition associated with the mobile device 104 based on the at least one image 410 may be executed remotely with respect to the mobile device 104 and/or the mobile device 106 via the communications network 110.

In some embodiments, a trained model of the one or more trained models 108 may correspond to a trained model as discussed in greater detail in commonly owned U.S. Pat. No. 11,704,887, titled “System, method, apparatus, and computer program product for utilizing machine learning to process an image of a mobile device to determine a mobile device integrity status,” and issued on Jul. 18, 2023, which is hereby incorporated by reference in its entirety.

In some embodiments, the mobile device 106 may generate a modified version of the at least one image 410 by performing image processing with respect to the at least one image 410. The image processing may include, but is not limited to, digitally enhancing, applying one or more digital image filters, cropping, altering brightness, and/or modifying one or more other visual features of the at least one image 410. In some embodiments, the image processing may be performed by a trained model configured for one or more image processing techniques. Additionally, the mobile device 106 may cause transmission of the modified version of the at least one image 410 to the mobile device condition status system 102 to cause analysis of the at least one image 410 and/or to determine a condition associated with the mobile device 104. For example, the mobile device condition status system 102 may analyze the modified version of the at least one image 410 via one or more other trained models (e.g., the one or more trained models 108).

In some embodiments, a user interface may be rendered as part of a particular application accessible via the mobile device 104 and/or the mobile device 106. In some embodiments, the application may embody a user-facing application providing access to functionality of the mobile device condition status system 102. Alternatively or additionally, in some embodiments, a user interface may be rendered within a web browser session that is hosted by or otherwise grants access to the mobile device condition status system 102, for example via accessing a particular web endpoint via a browser application on the mobile device 104 and/or the mobile device 106. It will be appreciated that a user interface may include any number of a myriad of different interface element types to present visualization data associated a mobile device condition status session. For example, in some embodiments, a user interface includes one or more interactive graphic elements, text labels, one or more buttons, one or more hyperlinks (e.g., where user interaction with the hyperlink initiates rendering of further detail associated with the data underlying the element with which the user interacted), and/or the like. In some embodiments, the mobile device 104 and the mobile device 106 utilize a web browser session associated with the mobile device condition status system 102 to enable a mobile device condition status session. In other embodiments to enable a mobile device condition status session, the mobile device 104 utilizes an application installed on the mobile device 104 and the mobile device 106 utilize a web browser session associated with the mobile device condition status system 102.

### Example Methods

Having described example systems and apparatuses, related data flows, and user interfaces in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depict a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

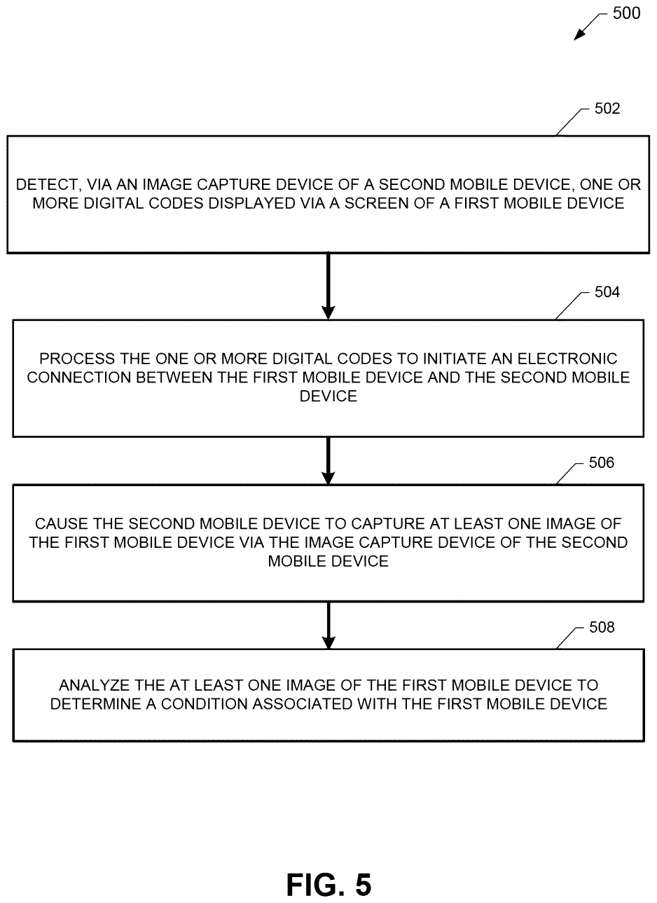

FIG. 5 illustrates a process 500 depicting example operations for utilizing digital codes to capture and/or analyze an image of a mobile device to determine a mobile device condition status in accordance with one or more embodiments of the present disclosure. The process 500 embodies an example computer-implemented method. In some embodiments, the process 500 is embodied by computer program code stored on a non-transitory computer-readable storage medium of a computer program product configured for execution to perform the process as depicted and described. Alternatively or additionally, in some embodiments, the process 500 is performed by one or more specially configured computing devices, such as the mobile device condition status apparatus 200 alone or in communication with one or more other component(s), device(s), system(s), and/or the like. In this regard, in some embodiments, the mobile device condition status apparatus 200 is specially configured by computer-coded instructions (e.g., computer program instructions) stored thereon, for example in the memory 204 and/or another component depicted and/or described herein and/or otherwise accessible to the mobile device condition status apparatus 200, for performing the operations as depicted and described. In some embodiments, the mobile device condition status apparatus 200 is in communication with one or more external apparatus(es), system(s), device(s), and/or the like, to perform one or more of the operations as depicted and described. For example, the mobile device condition status apparatus 200 in some embodiments is in communication with the mobile device 104 and/or the mobile device 106. For purposes of simplifying the description, the process 500 is described as performed by and from the perspective of the mobile device condition status apparatus 200.

According to some examples, the process 500 includes detecting, via an image capture device of a second mobile device, one or more digital codes displayed via a screen of a first mobile device, at block 502. According to some examples, the process 500 additionally or alternatively includes processing the one or more digital codes to initiate an electronic connection between the first mobile device and the second mobile device, at block 504. According to some examples, the process 500 additionally or alternatively includes causing the second mobile device to capture at least one image of the first mobile device via the image capture device of the second mobile device, at block 506. According to some examples, the process 500 additionally or alternatively includes analyzing the at least one image of the first mobile device to determine a condition associated with the first mobile device, at block 508.

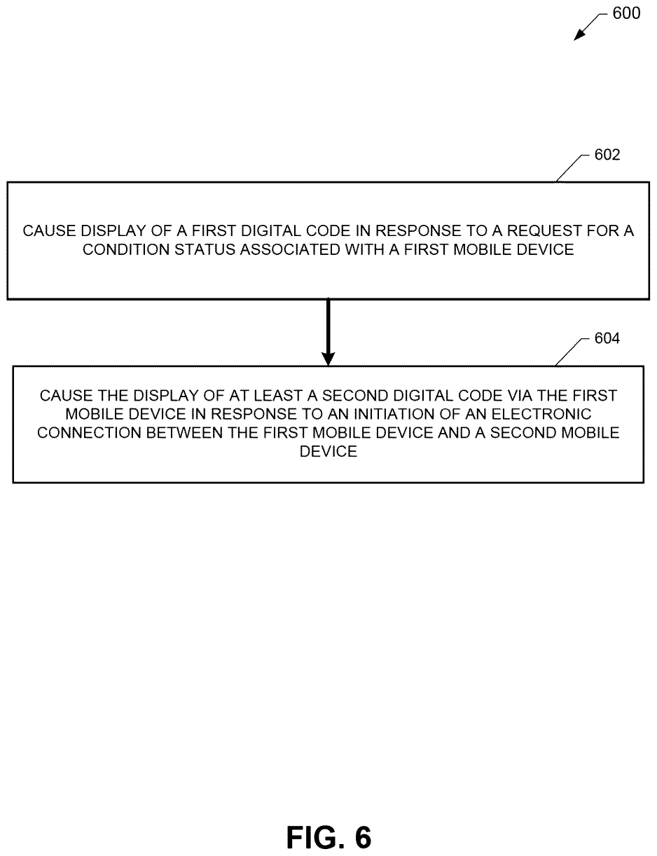

FIG. 6 illustrates a process 600 depicting example operations for utilizing digital codes to capture and/or analyze an image of a mobile device to determine a mobile device condition status in accordance with one or more embodiments of the present disclosure. The process 600 embodies an example computer-implemented method. In some embodiments, the process 600 is embodied by computer program code stored on a non-transitory computer-readable storage medium of a computer program product configured for execution to perform the process as depicted and described. Alternatively or additionally, in some embodiments, the process 600 is performed by one or more specially configured computing devices, such as the mobile device 104 alone or in communication with one or more other component(s), device(s), system(s), and/or the like. In this regard, in some embodiments, the mobile device 104 is specially configured by computer-coded instructions (e.g., computer program instructions) stored thereon, for example in the memory 314 and/or another component depicted and/or described herein and/or otherwise accessible to the mobile device 104, for performing the operations as depicted and described. In some embodiments, the mobile device 104 is in communication with one or more external apparatus(es), system(s), device(s), and/or the like, to perform one or more of the operations as depicted and described. For example, the mobile device 104 in some embodiments is in communication with the mobile device condition status apparatus 200 and/or the mobile device 106. For purposes of simplifying the description, the process 600 is described as performed by and from the perspective of the mobile device 104.

According to some examples, the process 600 includes causing display of a first digital code in response to a request for a condition status provided by a first mobile device, at block 602. For example, the first mobile device (e.g., the mobile device 104) may establish a first session with a server (e.g., the mobile device condition status system 102) to cause display of the first digital code via a display of the first mobile device. In some embodiments, the first digital code may include a URL for another device (e.g., a second mobile device). According to some examples, the process 600 additionally or alternatively includes causing the display of at least a second digital code via the first mobile device in response to an initiation of an electronic connection between the first mobile device and a second mobile device, at block 604. For example, in response to the electronic connection (e.g., an HTTPS connection), the display of the first mobile device may render the second digital code to facilitate a second session with the server (e.g., the mobile device condition status system 102) to enable providing a mobile device condition status associated with the first mobile device via the server. In some embodiments, the second digital code may be displayed in response to the URL associated with the first digital code being accessed by the second mobile device.

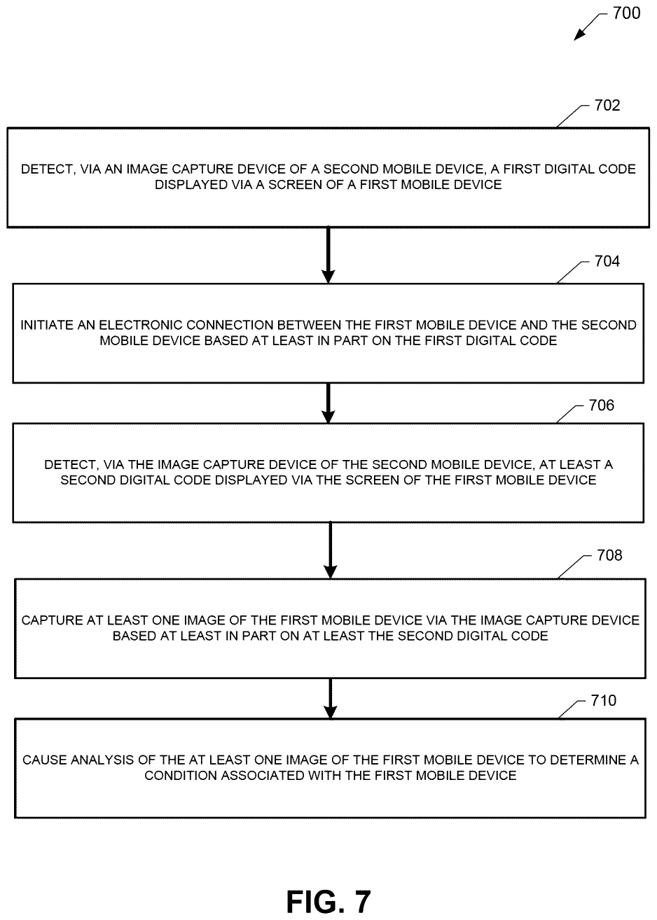

FIG. 7 illustrates a process 700 depicting example operations for utilizing digital codes to capture and/or analyze an image of a mobile device to determine a mobile device condition status in accordance with one or more embodiments of the present disclosure. The process 700 embodies an example computer-implemented method. In some embodiments, the process 700 is embodied by computer program code stored on a non-transitory computer-readable storage medium of a computer program product configured for execution to perform the process as depicted and described. Alternatively or additionally, in some embodiments, the process 700 is performed by one or more specially configured computing devices, such as the mobile device 106 alone or in communication with one or more other component(s), device(s), system(s), and/or the like. In this regard, in some embodiments, the mobile device 106 is specially configured by computer-coded instructions (e.g., computer program instructions) stored thereon, for example in the memory 314 and/or another component depicted and/or described herein and/or otherwise accessible to the mobile device 106, for performing the operations as depicted and described. In some embodiments, the mobile device 106 is in communication with one or more external apparatus(es), system(s), device(s), and/or the like, to perform one or more of the operations as depicted and described. For example, the mobile device 106 in some embodiments is in communication with the mobile device condition status apparatus 200 and/or the mobile device 104. For purposes of simplifying the description, the process 700 is described as performed by and from the perspective of the mobile device 106.

According to some examples, the process 700 includes detecting, via an image capture device of a second mobile device, a first digital code displayed via a screen of a first mobile device, at block 702. According to some examples, the process 700 additionally or alternatively includes initiating an electronic connection between the first mobile device and the second mobile device based at least in part on the first digital code, at block 704. According to some examples, the process 700 additionally or alternatively includes detecting, via the image capture device of the second mobile device, at least a second digital code displayed via the screen of the first mobile device, at block 706. According to some examples, the process 700 additionally or alternatively includes capturing at least one image of the first mobile device via the image capture device based at least in part on at least the second digital code, at block 708. According to some examples, the process 700 additionally or alternatively includes causing analysis of the at least one image of the first mobile device to determine a condition associated with the first mobile device, at block 710. In some embodiments, the analysis of the at least one image is caused in response to an upload of the at least one image to the mobile device condition status system 102.

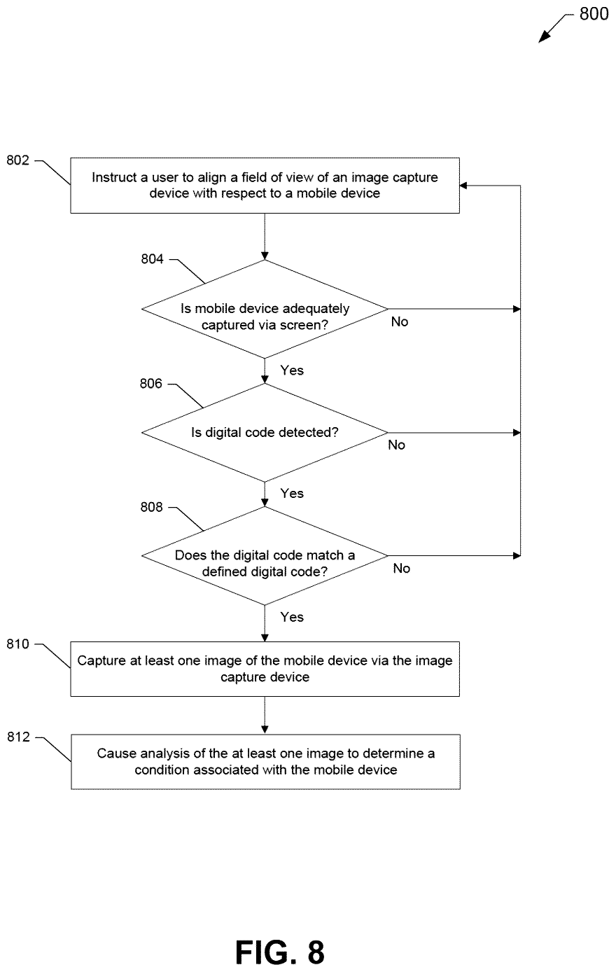

FIG. 8 illustrates a process 800 depicting example operations for utilizing digital codes to capture and/or analyze an image of a mobile device to determine a mobile device condition status in accordance with one or more embodiments of the present disclosure. The process 800 embodies an example computer-implemented method. In some embodiments, the process 800 is embodied by computer program code stored on a non-transitory computer-readable storage medium of a computer program product configured for execution to perform the process as depicted and described. Alternatively or additionally, in some embodiments, the process 800 is performed by one or more specially configured computing devices, such as the mobile device 106 alone or in communication with one or more other component(s), device(s), system(s), and/or the like. In this regard, in some embodiments, the mobile device 106 is specially configured by computer-coded instructions (e.g., computer program instructions) stored thereon, for example in the memory 314 and/or another component depicted and/or described herein and/or otherwise accessible to the mobile device 106, for performing the operations as depicted and described. In some embodiments, the mobile device 106 is in communication with one or more external apparatus(es), system(s), device(s), and/or the like, to perform one or more of the operations as depicted and described. For example, the mobile device 106 in some embodiments is in communication with the mobile device condition status apparatus 200 and/or the mobile device 104. For purposes of simplifying the description, the process 800 is described as performed by and from the perspective of the mobile device 106.

According to some examples, the process 800 includes instructing a user to align a field of view of an image capture device with respect to a mobile device, at 802. At 804, the process 800 determines whether the mobile device is adequately captured via a screen. If no (e.g., the mobile device is not adequately captured via the screen), the process 800 returns to 802 to instruct the user to align the field of view of the image capture device with respect to the mobile device. However, if yes (e.g., the mobile device is adequately captured via the screen), the process 800 proceeds to 806. At 806, the process 800 determines whether a digital code is detected. If no (e.g., a digital code is not detected), the process 800 returns to 802 to instruct the user to align the field of view of the image capture device with respect to the mobile device. However, if yes (e.g., a digital code is detected), the process 800 proceeds to 808. At 808, the process 800 determines whether the digital code matches a defined digital code. The defined digital code may be, for example, a random digital code generated by the mobile device condition status system 102. If no (e.g., the digital code does not match a defined digital code), the process 800 returns to 802 to instruct the user to align the field of view of the image capture device with respect to the mobile device. However, if yes (e.g., the digital code matches the defined digital code), the process 800 proceeds to 810. According to some examples, the process 800 includes additionally or alternatively includes capturing at least one image of the mobile device via the image capture device, at 810. According to some examples, the process 800 includes additionally or alternatively includes causing analysis of the at least one image to determine a condition associated with the mobile device, at 812.

In various embodiments, additional or alternative instructions may be displayed to the user via the first device and/or second device, including but not limited to instructions for moving the devices closer together or farther apart, instructions for aligning the first device with a box displayed on the screen of the second device, and/or other messages.

In some embodiments, the condition associated with the mobile device (e.g., the mobile device 104) may trigger one or more downstream processes. For example, a repair for the mobile device may be triggered based on the determined condition (e.g., in response to a determination that the mobile device is associated with damage). In another example, a notification may be presented via a user interface of another mobile device (e.g., the mobile device 106) to alter one or more settings of an image capture device (e.g., an image capture device of the mobile device 106), clean a lens of the image capture device, etc. to enable capture of a new image associated with the mobile device (e.g., the mobile device 104). In yet another example, a hardware component of another mobile device (e.g., the mobile device 106) or a server device (e.g., the mobile device condition status system 102 or another server system) may be controlled based on the condition associated with the mobile device (e.g., the mobile device 104). In yet another example, a value (e.g., a trade-in value) of the mobile device 104 may be determined based on the determined condition. In yet another example, a repair recommendation for the mobile device 104 may be determined based on the determined condition. In yet another example, it may be determined whether the mobile device 104 qualifies for a particular service (e.g., whether the mobile device 104 is eligible for insurance) based on the determined condition. In yet another example, one or more automated instructions and/or actions may be initiated between devices, systems, servers, networks, etc. based on the condition associated with the mobile device (e.g., the mobile device 104).

### Example User Interfaces

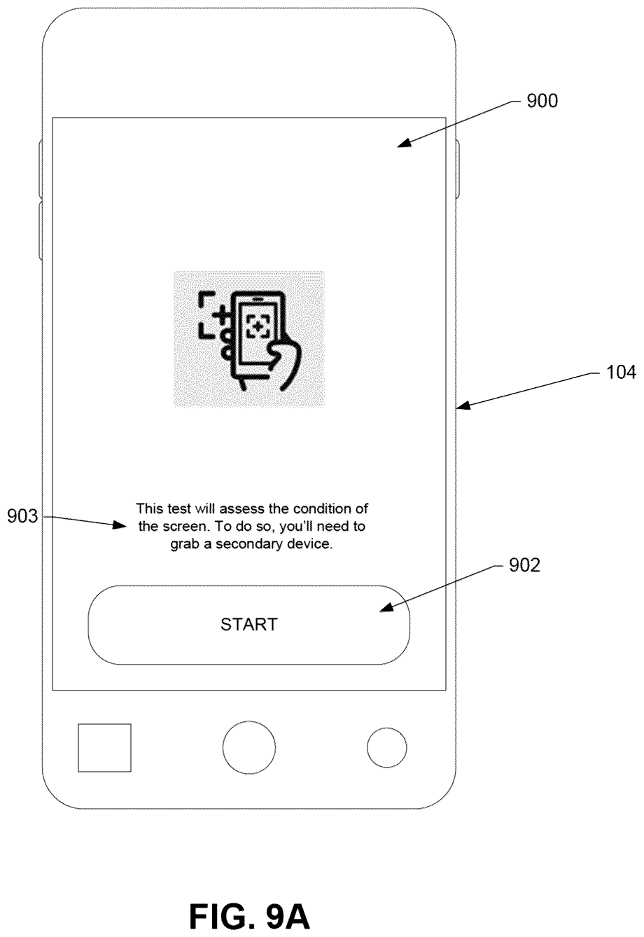

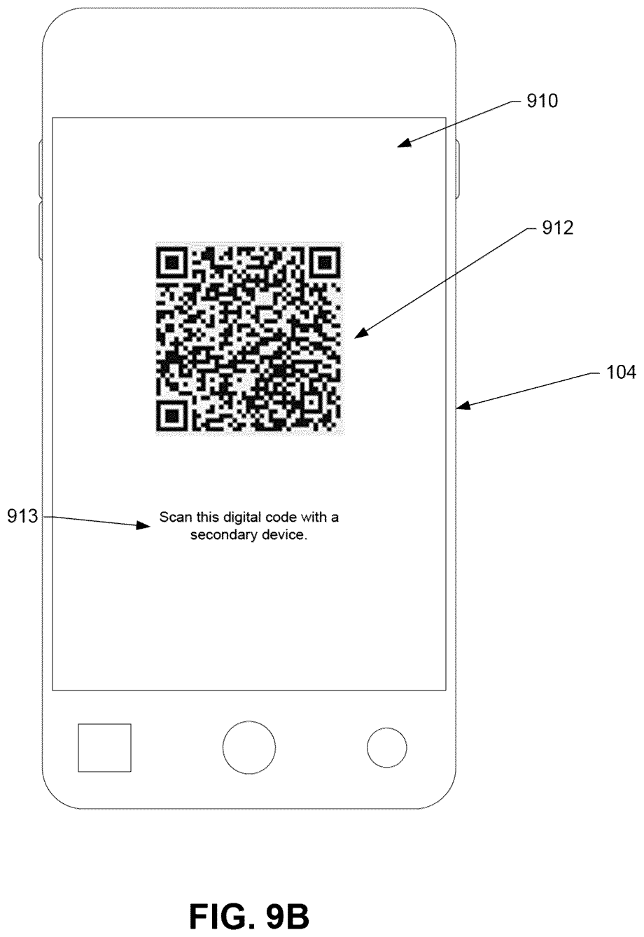

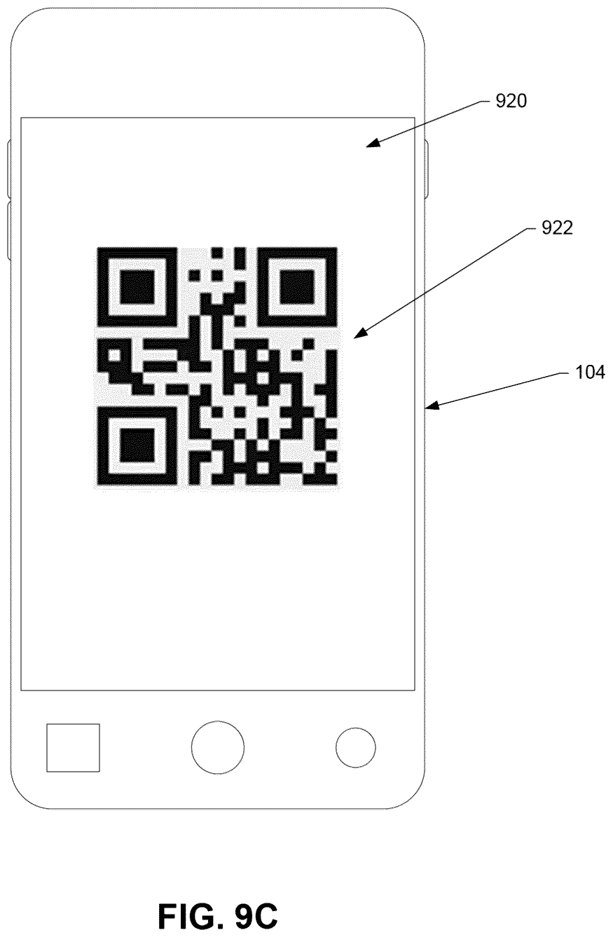

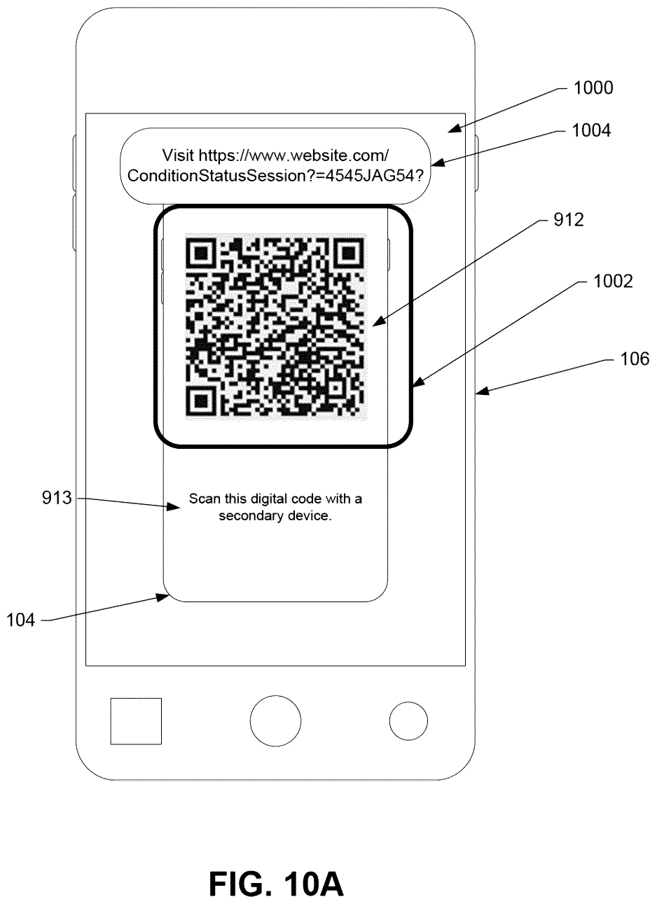

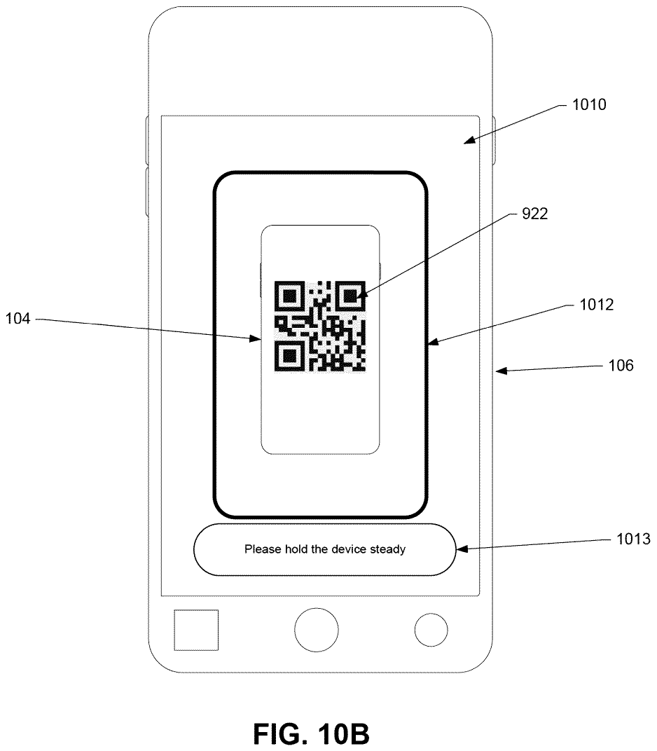

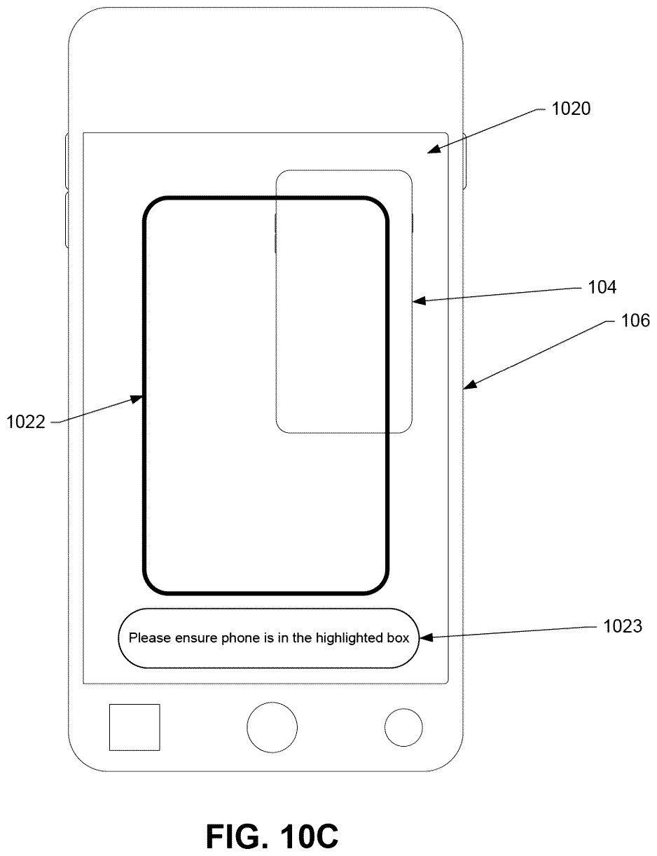

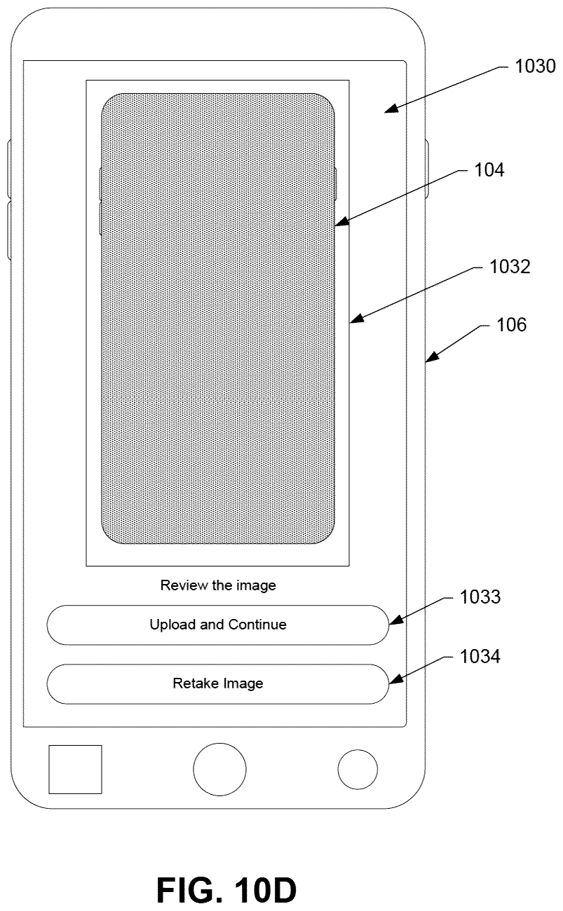

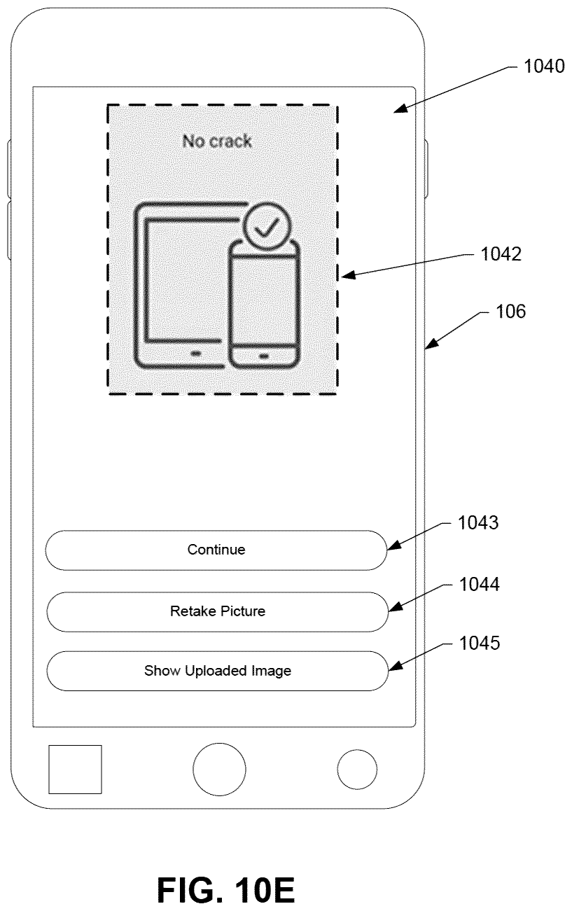

Example embodiments may provide one or more user interfaces associated with utilizing digital codes to capture and/or analyze an image of a mobile device to determine a mobile device condition status. According to some embodiments, a user may be instructed to utilize the mobile device 104 and/or the mobile device 106 to facilitate the mobile device condition status session associated with the mobile device condition status system 102. For example, FIGS. 9A, 9B, and 9C are examples of user interfaces associated with utilizing digital codes to capture and/or analyze an image of a mobile device to determine a mobile device condition status in accordance with one or more embodiments of the present disclosure. Additionally, FIGS. 10A, 10B, 10C, 10D, and 10E are other examples of user interfaces associated with utilizing digital codes to capture and/or analyze an image of a mobile device to determine a mobile device condition status in accordance with one or more embodiments of the present disclosure.

In some embodiments, the user interfaces illustrated in FIGS. 9A-9C may be rendered via a display screen of the mobile device 104. For example, as illustrated in FIG. 9A, a user interface 900 of the mobile device 104 may render an interactive graphical element 902 to initiate the mobile device condition status session associated with the mobile device condition status system 102. In some embodiments, the user interface 900 may include a description 903 that instructs a user to obtain access to a secondary device (e.g., the mobile device 106) to further facilitate the mobile device condition status session associated with the mobile device condition status system 102.

As illustrated in FIG. 9B, a user interface 910 of the mobile device 104 may render a digital code 912. In some embodiments, the digital code 912 may be a first digital code of the one or more digital codes 404. The digital code 912 may be configured to initiate an electronic connection between the mobile device 104 and the mobile device 106. For example, the digital code 912 may include an electronic connection command that initiates an electronic connection between the mobile device 104 and the mobile device 106 in response to the digital code 912 being captured via an image capture device of the mobile device 106. In some embodiments, the digital code 912 may include a URL to enable the electronic connection between the mobile device 104 and the mobile device 106. In some embodiments, the electronic connection command associated with the digital code 912 may be a web browser session command. In some embodiments, the electronic connection command associated with the digital code 912 may be an HTTPS command. In some embodiments, the user interface 910 may include a description 913 that instructs a user to scan the digital code 912 with a secondary device (e.g., the mobile device 106) to further facilitate initiation of an electronic connection between the mobile device 104 and the mobile device 106.

As illustrated in FIG. 9C, a user interface 920 of the mobile device 104 may render a digital code 922. In some embodiments, the digital code 922 may be a second digital code of the one or more digital codes 404. The digital code 922 may be configured to initiate capture of at least one image of the mobile device 104 via an image capture device of the mobile device 106 in response to the digital code 922 being captured via the image capture device of the mobile device 106 and/or in response to the digital code 922 captured via the image capture device of the mobile device 106 being authenticated by the mobile device condition status system 102. In some embodiments, the digital code 922 is a dynamic digital code of a sequence of dynamic digital codes rendered via the user interface 920 of the mobile device 104.

In some embodiments, the user interfaces illustrated in FIGS. 10A-10E may be rendered via a display screen of the mobile device 106. For example, as illustrated in FIG. 10A, a user interface 1000 of the mobile device 106 may be rendered. In some embodiments, the user interface 1000 may render a bounding box 1002. The bounding box 1002 may be aligned with a view of the mobile device 104 that displays the digital code 912. For example, a field of view of an image capture device of the mobile device 106 may be oriented to align the bounding box 1002 rendered via the user interface 1000 with a view of the digital code 912 concurrently displayed via the user interface 1000. In some embodiments, the user interface 1000 may correspond to a camera application interface of the mobile device 106. The view of the mobile device 104 concurrently displayed via the user interface 1000 may correspond to the user interface 910 rendered via the screen of the mobile device 104. In some embodiments, the user interface 1000 may include an indicator 1004 that indicates that the mobile device 106 is currently communicatively coupled to the mobile device condition status system 102 and/or the mobile device 104 via the mobile device condition status session (e.g., the web browser session) associated with the mobile device condition status system 102. In some embodiments, a user may interact with the indicator 1004 to cause rendering of a web browser via the mobile device 106.

As illustrated in FIG. 10B, a user interface 1010 of the mobile device 106 may render a bounding box 1012. The bounding box 1012 may be aligned with a view of the mobile device 104 that displays the digital code 922. For example, a field of view of an image capture device of the mobile device 106 may be oriented to align the bounding box 1012 rendered via the user interface 1010 with a view of the mobile device 104 and/or a view of the digital code 922 concurrently displayed via the user interface 1010. The view of the mobile device 104 concurrently displayed via the user interface 1010 may correspond to the user interface 920 rendered via the screen of the mobile device 104. In some embodiments, the user interface 1010 may include a description 1013 that instructs a user to hold the mobile device 106 steady, to point an image capture device of the mobile device 106 at a screen of the mobile device 104, to move an image capture device of the mobile device 106 closer to a screen of the mobile device 104, and/or another type of instruction to facilitate capture of an image of the mobile device 104 via an image capture device of the mobile device 106.

As illustrated in FIG. 10C, a user interface 1020 of the mobile device 106 may render a bounding box 1022. The bounding box 1022 may be oriented with a view of the mobile device 104. For example, a field of view of an image capture device of the mobile device 106 may be oriented to align the bounding box 1022 rendered via the user interface 1020 with a view of the mobile device 104 concurrently displayed via the user interface 1020. In some embodiments, the user interface 1020 may include a description 1023 that instructs a user to align a field of view of the image capture device of the mobile device 106 with the display of the mobile device 104 in response to a determination that the bounding box 1022 is not aligned with the display of the mobile device. In some embodiments, a trained model of the one or more trained models 108 may be executed locally on the mobile device 106, or executed remotely via the communications network 110 with respect to the mobile device 106, to render the bounding box 1022 via the user interface 1020 of the mobile device 106. In some embodiments, the trained model may repeatedly scan and/or evaluate for a mobile device image within the bounding box 1022.

As illustrated in FIG. 10D, a user interface 1030 of the mobile device 106 may render an image 1032. The image 1032 may be an image of the mobile device 104 that is captured via an image capture device of the mobile device 106 based on the digital code 922. In some embodiments, the user interface 1030 may include an interactive graphical element 1033 that is configured to initiate analysis of the image 1032 in response to an interaction with the interactive graphical element 1033 via the user interface 1030. For example, the analysis of the image 1032 may determine a condition associated with the mobile device 104. In some embodiments, an interaction with the interactive graphical element 1033 via the user interface 1030 may cause transmission of the image 1032 to the mobile device condition status system 102 via the communications network 110 to cause analysis of the image 1032 via the mobile device condition status system 102. In some embodiments, the user interface 1030 may additionally or alternatively include an interactive graphical element 1034 that is configured to initiate capture of a new image of the mobile device 104 via the image capture device of the mobile device 106. For example, an interaction with the interactive graphical element 1034 via the user interface 1030 may initiate display of a new digital code via the screen of the mobile device 104 to enable capture of a new image of the mobile device 104 via the image capture device of the mobile device 106.

In some embodiments, the description 1023 or another description displayed via a user interface of the mobile device 106 may instruct a user to turn the mobile device 104 over such that a non-screen side of the mobile device 104 is aligned within the bounding box 1022 rendered via the user interface 1020. As such, in some embodiments, the image 1032 may capture a non-screen side of the mobile device 104 rather than a screen of the mobile device 104 to enable analysis of a condition of the non-screen side of the mobile device 104. In some embodiments, the image 1032 may capture a screen of the mobile device 104 and a different image may capture a non-screen side of the mobile device after capturing and/or uploading the image 1032.

As illustrated in FIG. 10E, a user interface 1040 of the mobile device 106 may render an indication 1042 of a mobile device condition status for the mobile device 104. For example, the indication 1042 may indicate whether or not the analysis of the image 1032 results in identification of damage associated with the mobile device 104. In a non-limiting example, the indication 1042 may indicate whether or not the analysis of the image 1032 results in identification of a crack in a screen of the mobile device 104. In some embodiments, a trained model of the one or more trained models 108 may be remotely executed via the communications network 110 (e.g., rather than being executed locally on the mobile device 106) to perform the analysis of the image 1032.

In some embodiments, the user interface 1040 may additionally or alternatively include an interactive graphical element 1043 that is configured to continue the mobile device condition status session. For example, an interaction with the interactive graphical element 1043 via the user interface 1040 may initiate finalization of the mobile device condition status session. Additionally or alternatively, an interaction with the interactive graphical element 1043 via the user interface 1040 may enable and/or initiate enrollment an insurance plans, a warranty plan, an extended warranty plan, a protection plan (e.g., a device protection plan), and/or another service plan for the mobile device 104. Additionally or alternatively, an interaction with the interactive graphical element 1043 via the user interface 1040 may initiate submission of the mobile device condition status for the mobile device 104 to another system, database, and/or computing device to initiate enrollment an insurance plans, a warranty plan, an extended warranty plan, a protection plan (e.g., a device protection plan), and/or another service plan for the mobile device 104.

In some embodiments, the user interface 1040 may additionally or alternatively include an interactive graphical element 1044 that is configured to initiate capture of a new image of the mobile device 104 via the image capture device of the mobile device 106. For example, an interaction with the interactive graphical element 1044 via the user interface 1040 may initiate display of a new digital code via the screen of the mobile device 104 to enable capture of a new image of the mobile device 104 via the image capture device of the mobile device 106.

In some embodiments, the user interface 1040 may additionally or alternatively include an interactive graphical element 1045 that is configured to initiate a display of the image 1032 of the mobile device 104 for further user review via the screen of the mobile device 106.

Although an example processing system has been described above, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, i.e., one or more modules of computer program instructions, encoded on computer storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate physical components or media (e.g., multiple CDs, disks, or other storage devices).

The operations described herein may be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus may include special purpose logic circuitry, e.g., an FPGA (field programmable gate array) or an ASIC (application-specific integrated circuit). The apparatus may also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment may realize various different computing model infrastructures, such as web services, distributed computing and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments of the subject matter described herein may be implemented on a computer having a display device, e.g., a CRT (cathode ray tube) or LCD (liquid crystal display) monitor, for displaying information/data to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Embodiments of the subject matter described herein may be implemented in a computing system that includes a back-end component, e.g., as an information/data server, or that includes a middleware component, e.g., an application server, or that includes a front-end component, e.g., a client computer having a graphical user interface or a web browser through which a user may interact with an implementation of the subject matter described herein, or any combination of one or more such back-end, middleware, or front-end components. The components of the system may be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system may include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) may be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.
Clause 1. A system comprising: a second mobile device comprising one or more second processors and one or more second storage devices storing second instructions that are operable, when executed by the one or more second processors, to cause the one or more second processors to: detect, via an image capture device of the second mobile device, at least one digital code of one or more digital codes displayed via a screen of a first mobile device; capture at least one image of the first mobile device via the image capture device based at least in part on the at least one digital code; and cause analysis of the at least one image of the first mobile device to determine a condition associated with the first mobile device.
Clause 2. The system of clause 1, wherein the second instructions are further operable, when executed by the one or more second processors, to cause the one or more second processors to: cause the analysis of the at least one image of the first mobile device via at least one trained model at least approximately in real-time with respect to the capture of the at least one image.
Clause 3. The system of any one of the foregoing clauses, wherein the one or more digital codes comprise a sequence of dynamic digital codes.
Clause 4. The system of any one of the foregoing clauses, wherein the one or more digital codes comprise a hypertext transfer protocol secure (HTTPS) command that establishes an HTTPS connection between the first mobile device and the second mobile device via one or more server devices.
Clause 5. The system of any one of the foregoing clauses, wherein the first mobile device comprises one or more first processors and one or more first storage devices storing first instructions that are operable, when executed by the one or more first processors, to cause the one or more first processors to: cause display of a first digital code of the one or more digital codes in response to a request for a condition status associated with the first mobile device.
Clause 6. The system of clause 5, wherein the second instructions are further operable, when executed by the one or more second processors, to cause the one or more second processors to: detect the first digital code via the image capture device of the second mobile device; and initiate a web browser session based at least in part on the first digital code.
Clause 7. A computer-implemented method, comprising: detecting, via an image capture device of a second mobile device, one or more digital codes displayed via a screen of a first mobile device; processing the one or more digital codes to initiate an electronic connection between the first mobile device and the second mobile device; causing the second mobile device to capture at least one image of the first mobile device via the image capture device of the second mobile device; and analyzing the at least one image of the first mobile device to determine a condition associated with the first mobile device.
Clause 8. The computer-implemented method of clause 7, wherein analyzing the at least one image of the first mobile device comprises: analyzing the at least one image of the first mobile device via at least one trained model at least approximately in real-time with respect to the capture of the at least one image.
Clause 9. The computer-implemented method of any one of clauses 7-8, further comprising: detecting, via the image capture device of the second mobile device, a first digital code of the one or more digital codes displayed via the screen of the first mobile device; initiating a web browser session between the second mobile device and one or more server devices based at least in part on the first digital code; and causing the second mobile device to capture the at least one image of the first mobile device based at least in part on a second digital code of the one or more digital codes.
Clause 10. The computer-implemented method of any one of clauses 7-9, further comprising: receiving the at least one image from the second mobile device via a secure file transfer protocol.
Clause 11. The computer-implemented method of any one of clauses 7-10, further comprising: causing display of a notification via the second mobile device to align a field of view of the image capture device with respect to the first mobile device; and capturing the at least one image of the first mobile device via the image capture device in response to a determination that the field of view satisfies alignment criteria with respect to a bounding box associated with the first mobile device.
Clause 12. The computer-implemented method of any one of clauses 7-11, wherein causing the second mobile device to capture the at least one image comprises: controlling one or more image capture settings associated with the image capture device of the second mobile device at least approximately in real-time.
Clause 13. The computer-implemented method of any one of clauses 7-12, wherein analyzing the at least one image of the first mobile device comprises: applying a neural network model to the at least one image of the first mobile device to determine the condition associated with the first mobile device.
Clause 14. A computer program product, stored on at least one computer readable medium, comprising instructions that when executed by one or more computers cause the one or more computers to: detect, via an image capture device of a second mobile device, one or more digital codes displayed via a screen of a first mobile device; process the one or more digital codes to initiate an electronic connection between the first mobile device and the second mobile device; cause the second mobile device to capture at least one image of the first mobile device via the image capture device of the second mobile device; and analyze the at least one image of the first mobile device to determine a condition associated with the first mobile device.
Clause 15. The computer program product of clause 14, wherein the instructions, when executed by the one or more computers, further cause the one or more computers to: detect a first digital code of the one or more digital codes via the image capture device of the second mobile device; initiate a web browser session based at least in part on the first digital code; and detect a second digital code of the one or more digital codes in response to an initiation of the web browser session.
Clause 16. The computer program product of any one of clauses 14-15, wherein the instructions, when executed by the one or more computers, further cause the one or more computers to: cause transmission of the at least one image to at least one service device via a hypertext transfer protocol secure (HTTPS) connection.
Clause 17. The computer program product of any one of clauses 14-16, wherein the one or more digital codes comprise metadata associated with the first mobile device, and wherein the instructions, when executed by the one or more computers, further cause the one or more computers to: determine whether a field of view of the image capture device comprises the first mobile device based at least in part on the metadata associated with the one or more digital codes; and capture at least one image of the first mobile device via the image capture device in response to a determination that the field of view of the image capture device comprises the first mobile device.
Clause 18. The computer program product of any one of clauses 14-17, wherein the instructions, when executed by the one or more computers, further cause the one or more computers to: generate a modified version of the at least one image by performing image processing with respect to the at least one image via a first trained model; and cause transmission of the modified version of the at least one image to one or more server device to determine the condition associated with the first mobile device via a second trained model.
Clause 19. The computer program product of any one of clauses 14-18, wherein the instructions, when executed by the one or more computers, further cause the one or more computers to: transmit a set of computer-executable instructions to the first mobile device to initiate display of the one or more digital codes via the screen of the first mobile device.
Clause 20. The computer program product of any one of clauses 14-19, wherein the instructions, when executed by the one or more computers, further cause the one or more computers to: transmit a set of computer-executable instructions to the second mobile device to cause the second mobile device to capture at least one image of the first mobile device via the image capture device of the second mobile device.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. A system comprising:
a second mobile device comprising one or more second processors and one or more second storage devices storing second instructions that are operable, when executed by the one or more second processors, to cause the one or more second processors to:
detect, via an image capture device of the second mobile device, at least one digital code of one or more digital codes displayed via a screen of a first mobile device;
capture at least one image of the first mobile device via the image capture device based at least in part on the at least one digital code; and
cause analysis of the at least one image of the first mobile device to determine a condition associated with the first mobile device.

2. The system of claim 1, wherein the second instructions are further operable, when executed by the one or more second processors, to cause the one or more second processors to:
cause the analysis of the at least one image of the first mobile device via at least one trained model at least approximately in real-time with respect to the capture of the at least one image.

3. The system of claim 1, wherein the one or more digital codes comprise a sequence of dynamic digital codes.

4. The system of claim 1, wherein the one or more digital codes comprise a hypertext transfer protocol secure (HTTPS) command that establishes an HTTPS connection between the first mobile device and the second mobile device via one or more server devices.

5. The system of claim 1, wherein the first mobile device comprises one or more first processors and one or more first storage devices storing first instructions that are operable, when executed by the one or more first processors, to cause the one or more first processors to:
cause display of a first digital code of the one or more digital codes in response to a request for a condition status associated with the first mobile device.

6. The system of claim 5, wherein the second instructions are further operable, when executed by the one or more second processors, to cause the one or more second processors to:
detect the first digital code via the image capture device of the second mobile device; and
initiate a web browser session based at least in part on the first digital code.

7. A computer-implemented method, comprising:
detecting, via an image capture device of a second mobile device, one or more digital codes displayed via a screen of a first mobile device;
processing the one or more digital codes to initiate an electronic connection between the first mobile device and the second mobile device;
causing the second mobile device to capture at least one image of the first mobile device via the image capture device of the second mobile device; and
analyzing the at least one image of the first mobile device to determine a condition associated with the first mobile device.

8. The computer-implemented method of claim 7, wherein analyzing the at least one image of the first mobile device comprises:
analyzing the at least one image of the first mobile device via at least one trained model at least approximately in real-time with respect to the capture of the at least one image.

9. The computer-implemented method of claim 7, further comprising:
detecting, via the image capture device of the second mobile device, a first digital code of the one or more digital codes displayed via the screen of the first mobile device;
initiating a web browser session between the second mobile device and one or more server devices based at least in part on the first digital code; and
causing the second mobile device to capture the at least one image of the first mobile device based at least in part on a second digital code of the one or more digital codes.

10. The computer-implemented method of claim 7, further comprising:
receiving the at least one image from the second mobile device via a secure file transfer protocol.

11. The computer-implemented method of claim 7, further comprising:
causing display of a notification via the second mobile device to align a field of view of the image capture device with respect to the first mobile device; and
capturing the at least one image of the first mobile device via the image capture device in response to a determination that the field of view satisfies alignment criteria with respect to a bounding box associated with the first mobile device.

12. The computer-implemented method of claim 7, wherein causing the second mobile device to capture the at least one image comprises:
controlling one or more image capture settings associated with the image capture device of the second mobile device at least approximately in real-time.

13. The computer-implemented method of claim 7, wherein analyzing the at least one image of the first mobile device comprises:
applying a neural network model to the at least one image of the first mobile device to determine the condition associated with the first mobile device.

14. A computer program product, stored on at least one computer readable medium, comprising instructions that when executed by one or more computers cause the one or more computers to:
detect, via an image capture device of a second mobile device, one or more digital codes displayed via a screen of a first mobile device;
process the one or more digital codes to initiate an electronic connection between the first mobile device and the second mobile device;
cause the second mobile device to capture at least one image of the first mobile device via the image capture device of the second mobile device; and
analyze the at least one image of the first mobile device to determine a condition associated with the first mobile device.

15. The computer program product of claim 14, wherein the instructions, when executed by the one or more computers, further cause the one or more computers to:
detect a first digital code of the one or more digital codes via the image capture device of the second mobile device;
initiate a web browser session based at least in part on the first digital code; and
detect a second digital code of the one or more digital codes in response to an initiation of the web browser session.

16. The computer program product of claim 14, wherein the instructions, when executed by the one or more computers, further cause the one or more computers to:
cause transmission of the at least one image to at least one service device via a hypertext transfer protocol secure (HTTPS) connection.

17. The computer program product of claim 14, wherein the one or more digital codes comprise metadata associated with the first mobile device, and wherein the instructions, when executed by the one or more computers, further cause the one or more computers to:
determine whether a field of view of the image capture device comprises the first mobile device based at least in part on the metadata associated with the one or more digital codes; and
capture at least one image of the first mobile device via the image capture device in response to a determination that the field of view of the image capture device comprises the first mobile device.

18. The computer program product of claim 14, wherein the instructions, when executed by the one or more computers, further cause the one or more computers to:
generate a modified version of the at least one image by performing image processing with respect to the at least one image via a first trained model; and
cause transmission of the modified version of the at least one image to one or more server device to determine the condition associated with the first mobile device via a second trained model.

19. The computer program product of claim 14, wherein the instructions, when executed by the one or more computers, further cause the one or more computers to:
transmit a set of computer-executable instructions to the first mobile device to initiate display of the one or more digital codes via the screen of the first mobile device.

20. The computer program product of claim 14, wherein the instructions, when executed by the one or more computers, further cause the one or more computers to:
transmit a set of computer-executable instructions to the second mobile device to cause the second mobile device to capture at least one image of the first mobile device via the image capture device of the second mobile device.
